(19) United States
(12) Patent Application Publication
(10) Pub. No.: US 2017/0068863 A1
(43) Pub. Date: Mar. 9, 2017

(54) OCCUPANCY DETECTION USING COMPUTER VISION

(71) Applicant: QUALCOMM Incorporated, San Diego, CA (US)

(72) Inventors: Zachary Rattner, San Diego, CA (US); Abhikrant Sharma, Hyderabad (IN); Vijay Ramakrishnan, Redwood City, CA (US); Rasjinder Singh, San Diego, CA (US)

(21) Appl. No.: 15/252,150

(22) Filed: Aug. 30, 2016

Related U.S. Application Data
(60) Provisional application No. 62/214,761, filed on Sep. 4, 2015.

(51) Int. Cl. G06K 9/00; G06K 9/32; G06T 7/00; G06K 9/66; G06K 9/34

(52) U.S. Cl. CPC G06K 9/00838; G06K 9/66; G06K 9/342; G06T 7/0081; G06K 9/3241; G06K 9/00362; G06T 2207/30242; G06T 2207/30268; G06T 2207/30196; G06T 2207/20144; G06T 2207/20081

(57) ABSTRACT

Occupancy in a vehicle is determined by maintaining a set of occupant regions detected in a video. An occupant region can be a bounding box around a face, and/or an occupied seat that does not overlap any bounding box. A count, specific to an occupant region, is set to zero when an overlap between the occupant region in a current frame in the video and a previous frame in the video, satisfies a first predetermined condition. When the overlap does not satisfy the first predetermined condition, the count which is specific to the occupant region is incremented and checked against a threshold in a second predetermined condition. When the count exceeds the threshold, that occupant region is removed from the set of occupant regions. The just-described operations are repeated, with additional occupant regions. A count of occupant regions currently in the set may be displayed or transmitted to a server.

### CROSS-REFERENCE TO PROVISIONAL APPLICATION

This application claims the benefit of and priority to U.S. Provisional Application No. 62/214,761 filed on Sep. 4, 2015 and entitled “OCCUPANCY DETECTION USING COMPUTER VISION”, which is incorporated herein by reference in its entirety.

### BACKGROUND

This patent application relates to devices and methods for using, on a scene which includes seats for occupants, e.g. in a cabin of a vehicle of a mass transit system (such as a bus, an airplane, or a coach of a train), one or more processor(s) to process images of the scene to determine occupancy of the seats, for example without use of a connection to a server.

### SUMMARY

In several aspects of described embodiments, occupancy of seats is determined automatically, by receiving from a camera, multiple images of a scene that contains the seats. The multiple images are processed automatically by one or more processor(s), to maintain in a memory, a set of counts corresponding to at least seats that are occupied by occupants. Each count, which corresponds to a seat, is automatically changed depending on an overlap between: (1) a bounding box around a prior region in a prior image indicative of an occupant, and (2) a bounding box around a current region in a current image which may be indicative of the occupant (or indicative of another occupant who may have changed seats).

Several such embodiments may check whether a specific condition is satisfied by a current count corresponding to a current seat, and store in the memory, a value indicative of occupancy, depending on an outcome of the check. The specific condition may, for example, compare the current count to a threshold. Use of a threshold implements a delay, in recognizing that a seat is no longer occupied. This delay reduces error in determining occupancy, because occupancy determination is prone to error for example due to temporary movement (or occlusion) of an occupant. In some embodiments, the threshold may be changed, for example, by automatically selecting the threshold from among multiple thresholds based on a signal from a sensor, the signal being indicative of whether a vehicle (in which the seats are mounted), is in a stationary state or alternatively in a moving state. In this manner, delay in recognition of an unoccupied seat may be varied, depending on whether the vehicle is stationary or moving. Specifically, a greater delay may be used while the vehicle is in a moving state (e.g. as occupants are unlikely to disembark) and less delay used while the vehicle is in a stationary state.

In some embodiments, the above-described value is indicative of occupancy of a current seat, wherein the value indicates the current seat as being occupied (e.g. in the form of a binary state), when the current count is at least less than the threshold T. The value may indicate the current seat as being unoccupied (e.g. in the form of another binary state) either when the current count is equal to the threshold, or alternatively when the current count is greater than the threshold, depending on the embodiment.

In certain embodiments, each count (hereinafter “current count”) in the above-described counts is maintained by setting the current count to zero when the overlap exceeds a limit, incrementing the current count when the overlap is less than or equal to the limit, and removing a bounding box from a set of bounding boxes (which are indicative of overall occupancy of the vehicle) when a threshold is exceeded by the current count. When maintaining the above-described counts, a current set of bounding boxes may be prepared, for example incrementally, to include a prior set of bounding boxes indicative of occupants in T prior images, and one or more new bounding boxes indicative of one or more new occupant(s) in the current image.

Depending on the embodiment, each region that is indicative of an occupant in an image, may be either a bounding box around a boundary of a face (also called “face bounding box”) of a person, or a bounding box around a seat (also called “seat bounding box”) that does not overlap any face bounding box. Some embodiments initially process an image using regions of face bounding boxes, and subsequently process seat bounding boxes only for those seats whose occupancy has not been determined by use of face bounding boxes.

It is to be understood that several other aspects of the invention will become readily apparent to those skilled in the art from the description herein, wherein it is shown and described various aspects by way of illustration. The drawings and detailed description below are to be regarded as illustrative in nature and not as restrictive.

### BRIEF DESCRIPTION OF DRAWINGS

FIG. 1A illustrates, in a high-level flow chart, acts (or operations) 121-125 performed by a processor 110 programmed with software in a memory 220 of an electronic device 100, in several aspects of described embodiments.

FIG. 1B illustrates, in an intermediate-level flow chart, operations and/or acts 131-137 performed by processor 110 in performing an operation 122 of FIG. 1A that maintains a set of counts corresponding to seats occupied, in some aspects of described embodiments.

FIG. 1C illustrates, in a low-level flow chart, an operation 131 of FIG. 1B performed by processor 110 to create a current set of regions indicative of occupancy, in some aspects of described embodiments

FIG. 2A illustrates, in a high-level flow chart, acts 211-217 performed by a processor 210 programmed with software 222 in a memory 220 of a computer 200 in a vehicle 299, in several aspects of described embodiments.

FIG. 2B illustrates, in a high-level block diagram, components within a computer 200 of the type illustrated in FIG. 2A.

FIG. 2C illustrates, in a high-level block diagram, a vehicle 299, in which is mounted computer 200, of the type illustrated in FIGS. 2A and 2B.

FIG. 3A illustrates, in an intermediate-level flow chart, acts 301-319 performed by processor 210 of the type shown in FIG. 2A, in some aspects of described embodiments.

FIG. 3B illustrates, in a low-level flow chart, acts 321-324 performed by processor 210 of the type shown in FIG. 3A, in some aspects of described embodiments.

FIG. 3C illustrates, in an intermediate-level flow chart, acts 331-333 and 341-356 and operation 360 performed by computer 200 of the type shown in FIG. 2A, in some aspects of described embodiments.

FIG. 3D illustrates, in an intermediate-level flow chart, acts 362-365 in an operation 360 in FIG. 3C which adds bounding boxes of seats, to a set 221 of bounding boxes, when needed.

FIG. 4A illustrates an image of interior of vehicle 299, in a frame of a video that may be processed as illustrated in FIG. 3C.

FIG. 4B illustrates the frame of FIG. 4A after edge extraction.

FIG. 4C illustrates the edge extracted image of FIG. 4B after processing by a classifier in a training phase 330 of FIG. 3C, to identify locations of seats in vehicle 299.

FIG. 4D illustrates coordinates of seats in vehicle 299, which are stored in memory 220, by the training phase 330 of FIG. 3C.

FIG. 5A illustrates an image which is captured in act 335 during normal operation of FIG. 3C in some illustrative embodiments.

FIG. 5B illustrates processing of the image of FIG. 5A by a face counter operation 340 during normal operation of FIG. 3C in some illustrative embodiments.

FIG. 5C illustrates processing of the image of FIG. 5A by a seat counter operation 350 during normal operation of FIG. 3C in some illustrative embodiments.

FIG. 5D illustrates a number of occupied seats, and indices of the occupied seats in vehicle 299, which are stored in memory 220, by normal operation 334 of FIG. 3C.

FIG. 6A illustrates bounding boxes of faces in the image of FIG. 5A, after four iterations during normal operation 334 of FIG. 3C.

FIG. 6B shows reports based on bounding boxes of FIG. 6A, as maintained in set 221 in memory 220.

FIG. 6C illustrates bounding boxes of faces in the image of FIG. 5A, by maintaining in set 221, bounding boxes around faces which are undetected in T successive frames, during normal operation 334 of FIG. 3C.

FIG. 6D shows reports based on bounding boxes of FIG. 6C, as maintained in set 221 in memory 220.

FIG. 7 illustrates processing of the image of FIG. 5A wherein bounding box 701 is classified as occupied and bounding box 702 is classified as empty, in some illustrative embodiments.

FIG. 8 illustrates, in an intermediate-level flow chart, operations and/or acts of a method 800 performed by processor 110 in some aspects of described embodiments.

### DETAILED DESCRIPTION

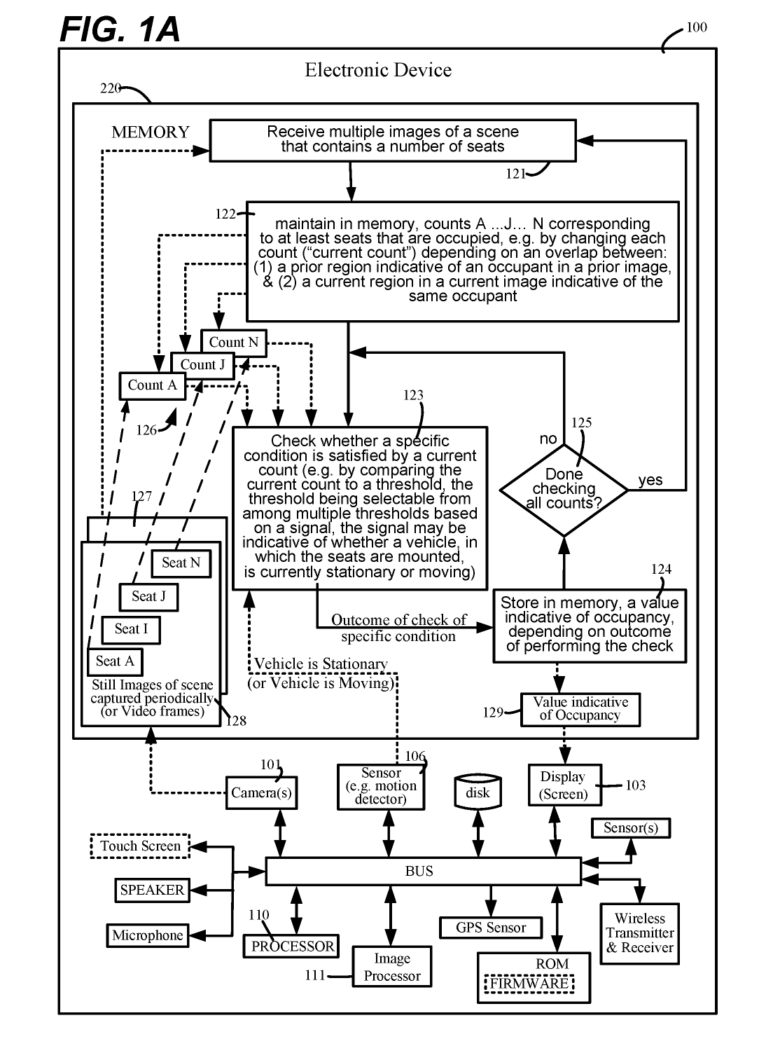

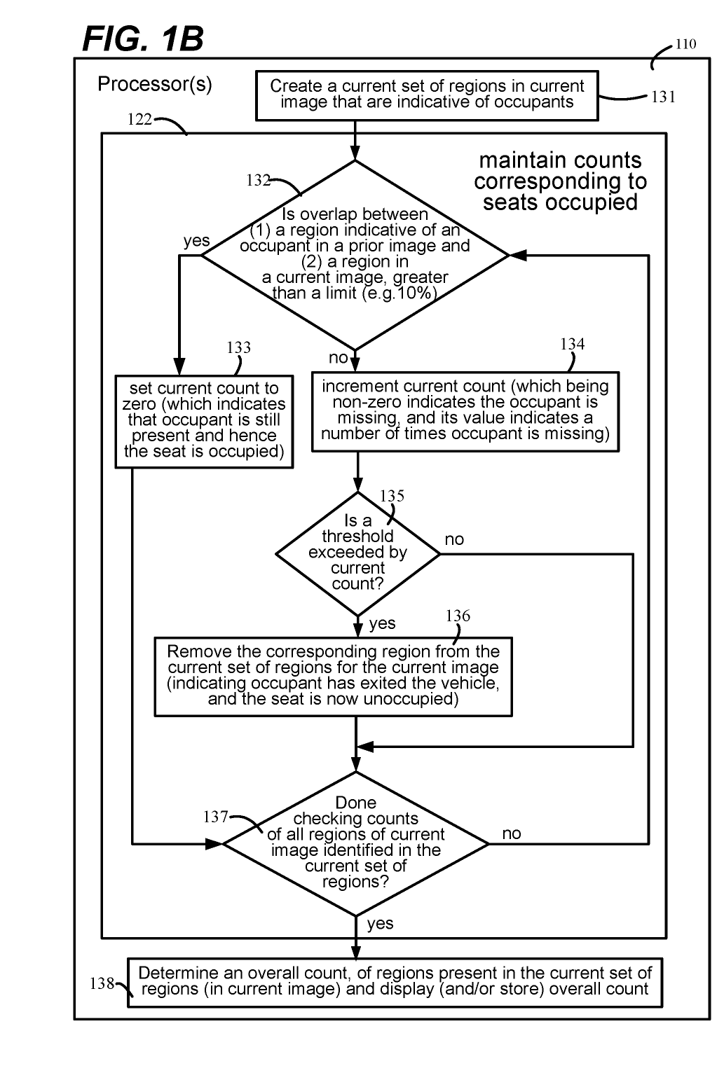

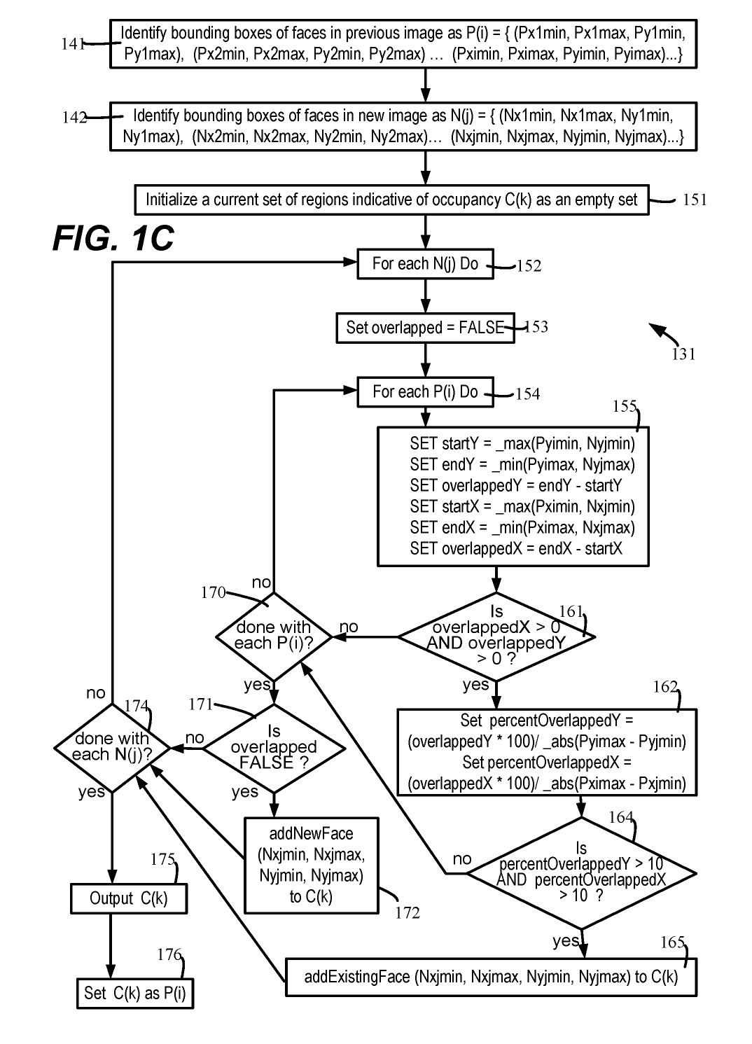

In several aspects of described embodiments, one or more processor(s) 210 within an electronic device 100 may be programmed by software in a non-transitory memory 120 (FIG. 1A) coupled thereto, to perform acts (or operations) 121-125. In performing acts 121-125, processor(s) 210 may maintain in the non-transitory memory 120, a set 126 of counts corresponding to at least seats that are occupied by occupants, as captured in images 127,128 by a camera 101.

More specifically, in several embodiments, in an act 121, processor 110 receives from camera 101, multiple images 127,128 of a scene inside a vehicle's cabin that contains several seats. The multiple images 127,128 are captured by camera 101 at different points in time, of the same scene. The scene may be, for example, in an interior of a cabin of a vehicle (e.g. a bus, an airplane, or a coach of a train) in which the seats are fixedly mounted.

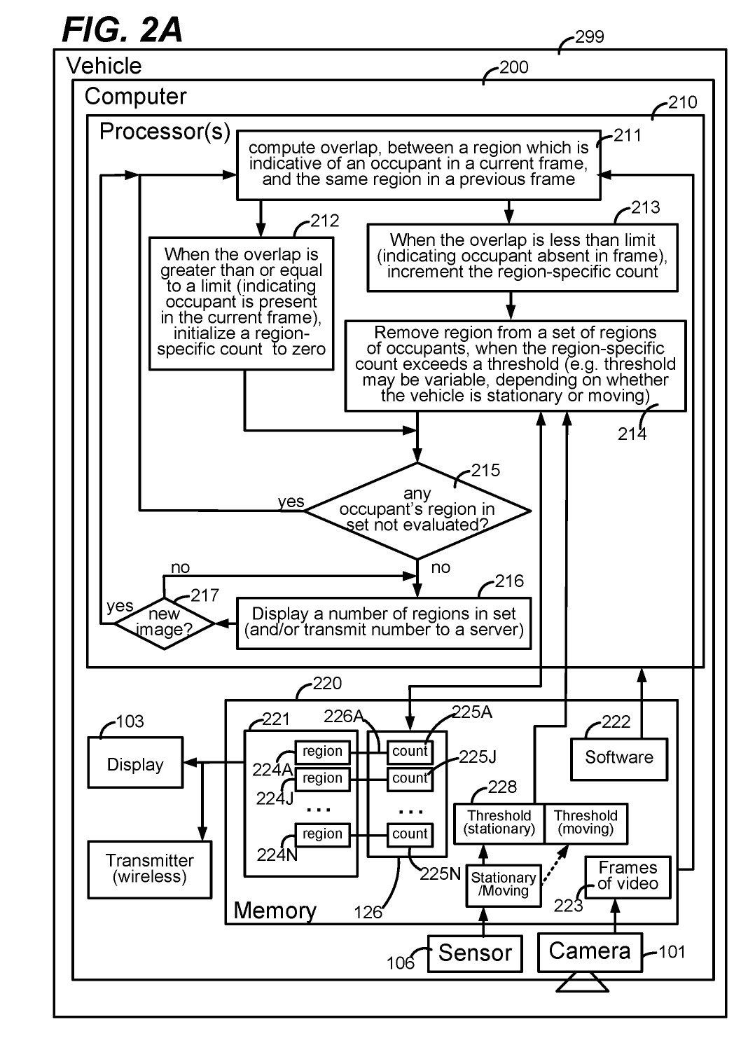

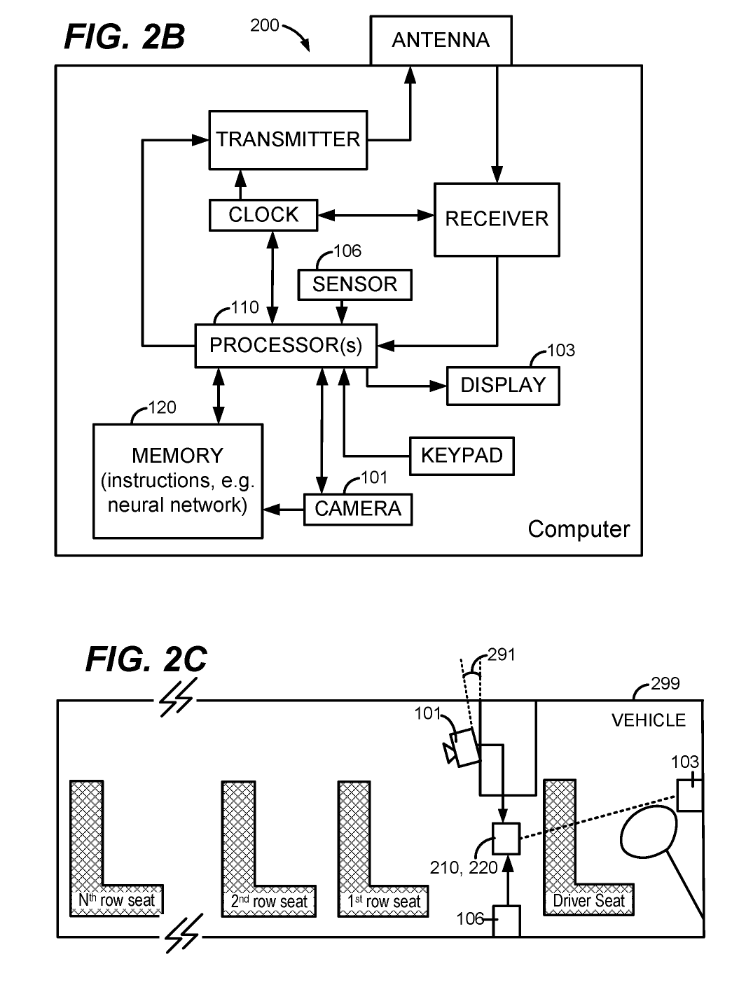

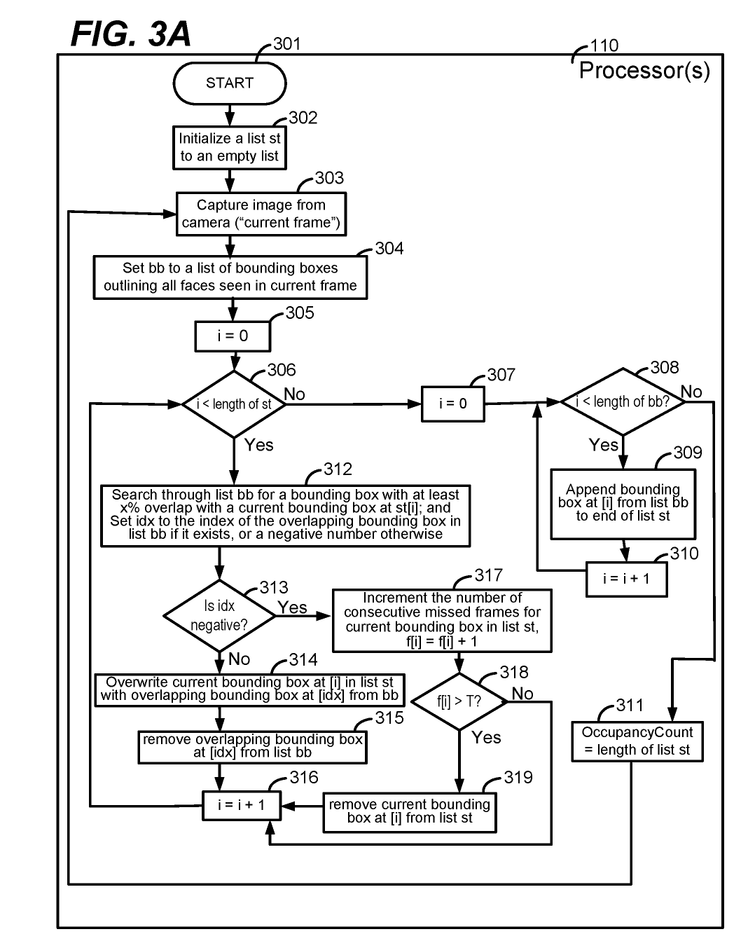

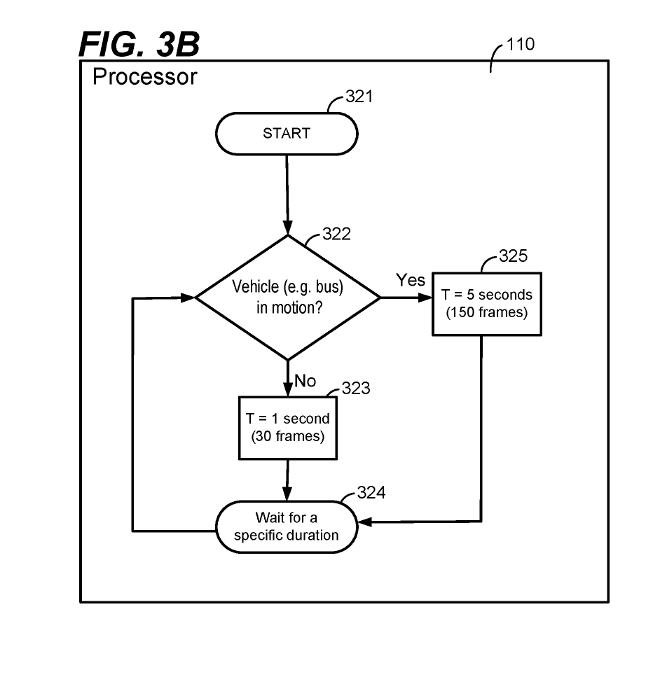

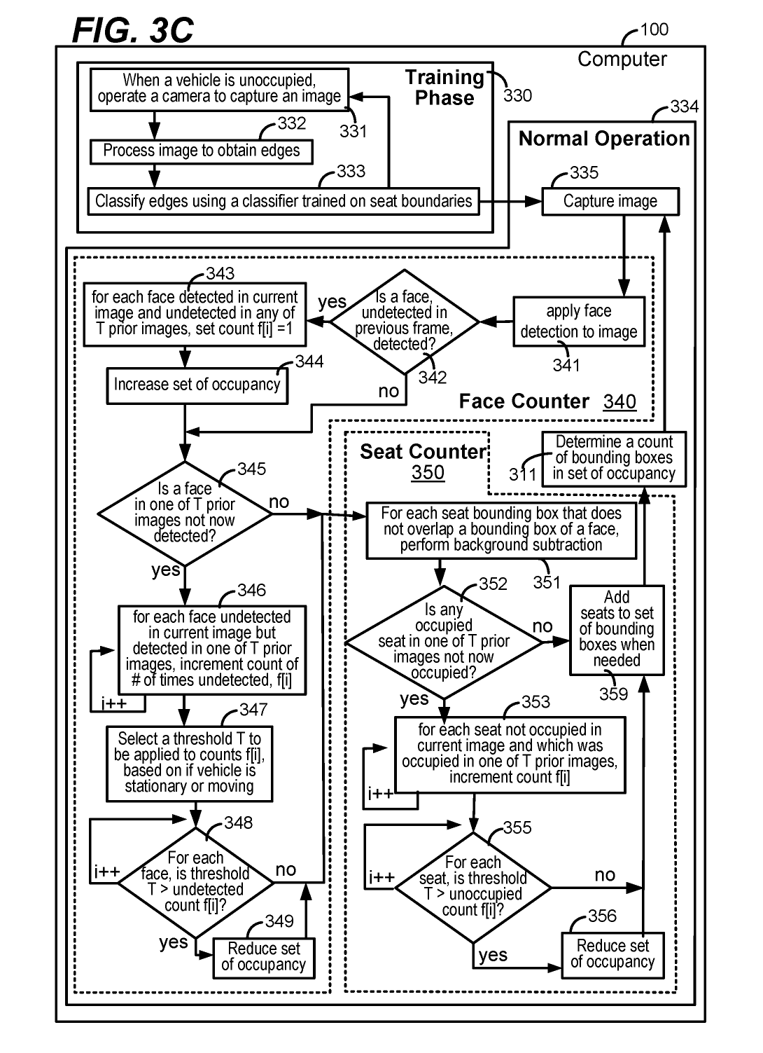

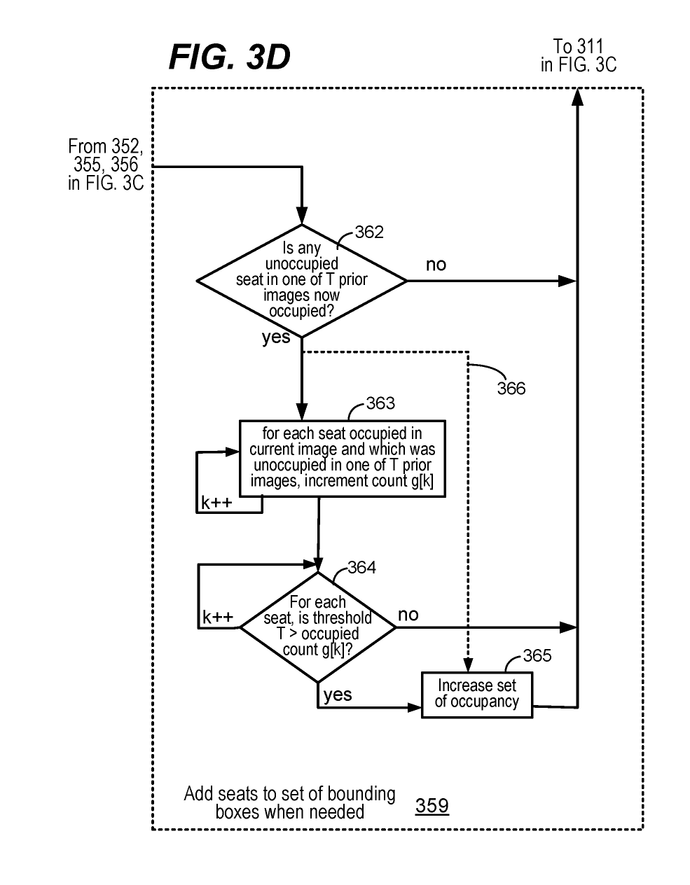

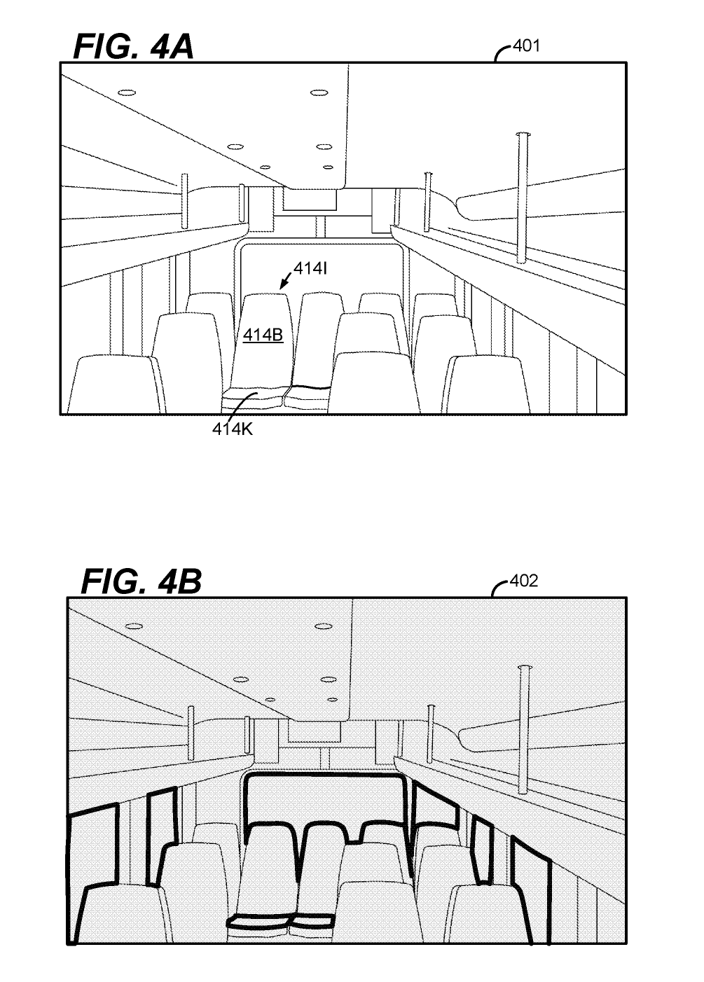

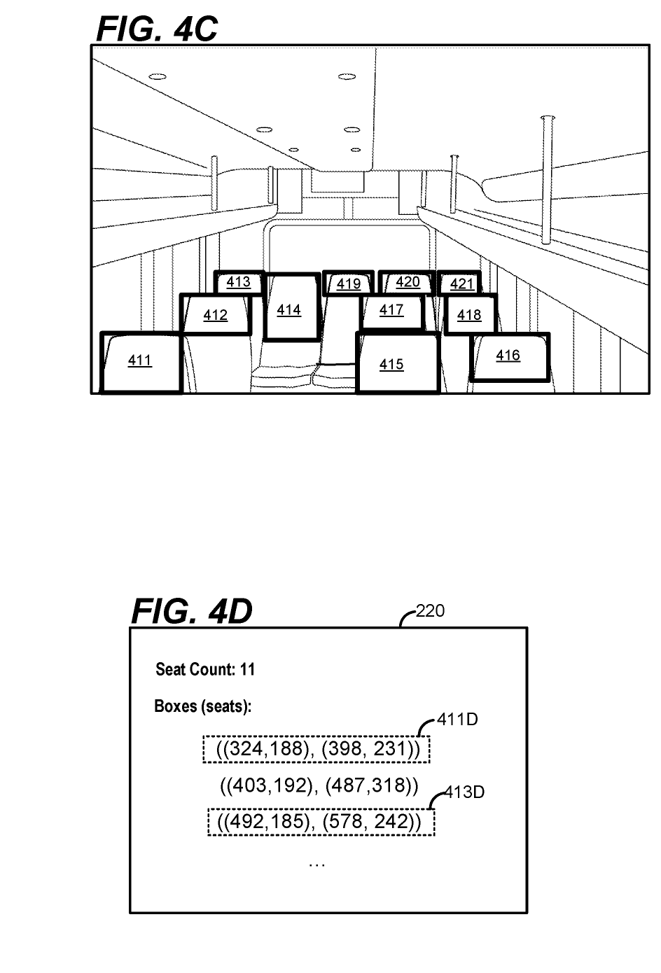

In certain embodiments, each seat I in an image (e.g. image 128 in FIG. 1A) includes two surfaces, e.g. a bottom surface 414B and a back surface 414K (see FIG. 4A) that are adjacent to one another and that are of sufficient sizes to accommodate a human (also called “occupant”), to enable the human to sit thereon. The just-described two surfaces of each seat have boundaries which are automatically recognizable in image 128 of an interior of vehicle 299 (FIGS. 2A-2C) that holds many such seats (e.g. 10 seats, 20 seats, or 30 seats, depending on a size of vehicle 299). Specifically, boundaries of seats in a scene may be automatically recognized, e.g. by a classifier implemented by processor 110 and trained on edges detected in similar images (and user input identifying which edges are seat boundaries and which are not) in a training phase 330 (FIG. 3A).

In some embodiments, each seat may be formed of a single surface that is sized to accommodate only one human (e.g. bucket seat), and one or more portions of a boundary of each such seat may be detectable in an image as described herein, e.g. by a classifier trained on images with user input identifying seat boundaries. In illustrative embodiments, a seat may constitute an area of a flat surface (e.g. a bench which enables one or more human(s) to sit thereon). In such embodiments, camera 101 may be mounted vertically overhead (e.g. so that mounting angle 291 in FIG. 2C is around 90°) and so that the flat surface of one or more seats (which may be oriented horizontally) is sufficiently imaged for the state of each seat to be automatically determined (as being empty or occupied), as described herein. Several embodiments use benches for seating, wherein each bench has one or more surface(s) sized to seat multiple humans, e.g. three humans, and in such embodiments a classifier is trained based on user input (e.g. seat width) to detect multiple seats even in the absence of any indicia in the image (such as edges) to demarcate seat boundaries within each bench.

In an operation 122 (FIG. 1A), processor 110 uses the multiple images 127,128 to maintain in memory, a set 126 of counts corresponding to at least seats that are occupied. In the example illustrated in FIG. 1A, the image 128 contains Seat A . . . Seat I . . . Seat J . . . and Seat N. In such embodiments, at least when Seat A, Seat J, and Seat N are occupied, operation 122 maintains Count A, Count J, and Count N corresponding thereto. Note that no count needs to be maintained for Seat I when it is unoccupied, although other embodiments may maintain counts for each and every seat in an image 128, whether or not the seat is occupied (i.e. may maintain a Count I even when seat I is unoccupied, in addition to maintaining Counts A, J and N corresponding to occupied Seats A, J and N).

In several embodiments, in performing operation 122, each count (“current count”) is changed, based on an overlap between (1) a prior region that is indicative of an occupant in a prior image (e.g. image 127 in FIG. 1A), and (2) a current region in the current image (e.g. image 128 in FIG. 1A) indicative of the same occupant. Thereafter, in an act 123, processor 110 checks whether a specific condition is satisfied, by a current count. For example, processor 110 may compare the current count to a threshold. Subsequently, in act 124, processor 110 stores in memory 220, a value 129 indicative of occupancy (also called “overall count”), depending on an outcome of performing the check in act 123. Then, in an act 125, processor 110 checks if all counts have been processed in this manner and if so returns to act 121 (described above), and if not returns to act 123 (also described above). In act 123, the threshold being used in some embodiments may be selectable from among multiple thresholds, based on a signal. The signal, depending on the embodiment, may be generated by a sensor (e.g. GPS, accelerometer) indicative of whether a vehicle, in which the seats A . . . I . . . J . . . N are mounted, is currently in a moving state or alternatively in a stationary state.

An overlap determined in operation 122 may be used in certain implementations of operations and/or acts 122-124 to determine, for example, whether a previously-detected face (in image 127) is not now detected (e.g. in image 128). Alternatively or additionally, the overlap may be used in certain implementations of operations and/or acts 122-124 to determine, for example, whether a previously-occupied seat (in image 127) is not now occupied (e.g. in image 128). A specific manner in which the set 126 of counts are changed and used depends on the embodiment. Some embodiments use set 126 (also called “counts set”) to deliberately introduce a delay in recognizing that a seat is unoccupied, for example use Count J to delay recognition of Seat J as unoccupied for a specific duration (or a specific number of images) while an occupant of Seat J is absent in the images. The specific duration may be variable, for example depending on threshold (described above).

In certain embodiments, operation 122 is implemented by processor 110 performing acts 132-137 illustrated in FIG. 1B, as follows. In several embodiments, prior to operation 122, an operation 131 (FIG. 1B) may be performed to create a set 221 of bounding boxes around regions in the current image (and/or regions in a prior image) that are indicative of occupants in the vehicle. Depending on the embodiment, operation 131 may be performed incrementally, for example by including bounding boxes around regions indicative of occupants in a prior image (e.g. image 127 in FIG. 1A) and further including bounding boxes around one or more new region(s) indicative of one or more new occupant(s) in the current image (e.g. image 128 in FIG. 1A).

Each bounding box formed by processor 110 of some embodiments may be a rectangle, with each side passing through a point on a boundary of a region indicative of an occupant (e.g. a face or an occupied seat) in an image, such that the point has an extreme coordinate (e.g. a smallest coordinate or a largest coordinate) among all points on the region's boundary. Moreover, in some embodiments, after operation 122, an act 138 (FIG. 1B) may be performed by processor 110, to determine how many bounding boxes are now present in set 221 (i.e. after image 128 is used to update set 221, in operation 122), e.g. by counting the bounding boxes in set 221, followed by displaying a result of counting (also called “overall count”) and/or storing the overall count in memory 220.

In some embodiments, a number of people in each frame may be automatically counted by processor 110, e.g. using face detection. More specifically, a set 221 of bounding boxes (also called “set of occupancy” or “occupancy set”) is automatically populated in several embodiments, by processor 110 using overlap between a prior image indicative of occupants before the present frame (e.g. no occupants, initially when a vehicle is empty), and a current image indicative of a number of people in the present frame (e.g. one occupant in the vehicle). More specifically, in some embodiments, an operation 131 (see FIG. 1B) automatically performed by processor 110 may identify faces that overlap, between a prior image and a current image, e.g. by performing the method illustrated in FIG. 1C (described after the next paragraph below) although other embodiments may identify overlapping faces in other ways. Alternatively, operation 131 may be performed in an image processor 111 (FIG. 1A) that may be included in electronic device 100 of some embodiments and configured with software instructions described herein, e.g. in reference to FIGS. 1A, 1B, 1C, etc.

In the certain embodiments, processor 110 performs an act 132 to check if an overlap between (1) a region indicative of an occupant in a prior image (e.g. image 127 in FIG. 1A) and (2) a region in a current image (e.g. image 128 in FIG. 1A), is greater than a limit (e.g. 70%). In act 132, if the answer is yes (indicating that the occupant (or another occupant) is seated) processor 110 goes to act 133, and if not (indicating that the occupant is missing) processor 110 goes to act 134. Act 132 of several embodiments does not require recognition of an occupant, and instead act 132 simply uses overlap between a prior image's region and a current image's region (which may be physically close or otherwise proximate to one another). In act 133, processor 110 initializes the current count to zero, which indicates that the occupant is still present and the seat is occupied. In act 134, processor 110 increments the current count. A non-zero current count indicates that the occupant is missing, and the value indicates a number of times that the occupant has been missing (e.g. a number of consecutive frames in which a bounding box of an occupant's face in a current frame does not meet an overlap condition relative to a bounding box in a prior frame).

After performing act 134, processor 110 goes to act 135 to check if a threshold is exceeded by the current count. If the answer in act 135 is yes, then processor 110 determines that the seat is now unoccupied (e.g. because occupant has exited the vehicle), and in act 136 processor 110 removes a region corresponding to the current count from the set 221 of bounding boxes (which as noted above, was created in act 131). After performing act 136, processor 110 goes to act 137. Processor 110 also goes to act 137 after performing act 133, and also when the answer is no in act 135. In act 137, processor 110 checks if counts of all regions of the current image, as identified in the set 221 of bounding boxes, have been processed, and if not returns to act 132. When the answer in act 137 is yes, then processor 110 goes to act 138 (described above).

While performing operation 122 (described above), some embodiments of processor 110 perform an operation 140 to identify overlapping faces in prior and current images as illustrated in FIG. 1C, as follows. Specifically, initially, in an act 141, processor 110 identifies in an image P, a group of bounding boxes of faces as P(i)={(Px1min, Px1max, Py1min, Py1max), (Px2min, Px2max, Py2min, Py2max) . . . (Pximin, Pximax, Pyimin, Pyimax) . . . }. A specific manner in which face bounding boxes are identified in act 141 depends on the embodiment. Specifically, some embodiments may use skin color detection and/or abstraction of difference with background and/or presence of one or more facial features, such as a nose, a mouth, two eyes and two ears and relative distances therebetween, and/or template matching, to identify one or more faces of humans in an image. One such method, as described in US Patent Publication 200481338 entitled “Face Identification Device and Face Identification Method” by Hideki Takenaka, Shiga, assigned to Omron Corporation, is incorporated by reference herein in its entirety. In some embodiments, after act 141, face bounding boxes are similarly identified in another act 142, by using a new image N which is captured after image P, to obtain another group of bounding boxes N(j)={(Nx1min, Nx1max, Ny1min, Ny1max), (Nx2min, Nx2max, Ny2min, Ny2max) . . . (Nxjmin, Nxjmax, Nyjmin, Nyjmax) . . . }.

An index of a new group of bounding boxes N(j) extracted from a new image need not synchronize with (and need not be the same number as) the index of an earlier group of bounding boxes P(i) extracted from the earlier image. For example, in act 141, the earlier group P(i) may be returned as ten face bounding boxes (with indexes P0, P1 . . . P9), and in act 142, a new group N(j) may be returned as only four face bounding boxes (with index N0, N1, N2, N3), and here the N0 can be any index between P0 to P5. For this reason, the method of FIG. 1C compares all combinations, as discussed below. In the just-described example, number of comparisons are 10*4=40.

After act 142, processor 110 initializes (in act 151) a set of regions indicative of occupancy C(k) as an empty set. Thereafter, processor 110 enters an outer loop in act 152, for each face bounding box N(j) in new image N identified in act 142 as follows. In act 153 within the just-described outer loop, processor 110 sets a flag in a variable named “overlapped” to the Boolean value FALSE, and then in act 154 enters an inner loop for each face bounding box P(i) in previous image P. Inside the inner loop, in an operation 155, processor 110 computes an amount of overlap between a face bounding box in the new image and another face bounding box in the previous image, along each of the two coordinates, namely x-coordinate and y-coordinate. For example, the y-coordinate overlap is determined in variable overlappedY, as a difference between variables endY and startY. Variable endY may be determined as min(Pyimax, Nyjmax), and variable startY may be determined as max(Pyimin, Nyjmin), with Pyimax and Piymin being the largest and smallest y-coordinates respectively of the face bounding box Pi in the prior image and Nyjmax and Nyjmin being the largest and smallest y-coordinates respectively of the face bounding box Nj in the new image. Similarly, the x-coordinate overlap may be determined in variable overlappedX, in operation 155 as another difference, between variables endX and startX.

Thereafter, processor 110 performs an act 161, to determine if each of the two just-determined variables namely overlappedX and overlappedY (which denote overlap along the x-axis and y-axis respectively) are greater than zero. If the answer in act 161 is yes, processor 110 goes to act 162 to compute percentage of overlap along each of the x-axis and y-axis, followed by act 164 to check if each of these two percentages is greater than a predetermined limit on overlap percentage (e.g. 10%). If the answer in act 164 is yes, then processor 110 performs act 165 wherein the bounding box of the face in the new image N of the current iteration is added (as an existing face) to the set 221 of bounding boxes which are indicative of occupancy of the vehicle, namely set C(k). Thereafter, processor 110 goes to act 174 to check if the outer loop has been completed (i.e. if all face bounding boxes in new image N have been processed), and if not returns to act 152.

In act 161 if the answer is no, or in act 164 if the answer is no, then processor 110 goes to act 170 to check if the inner loop has been completed (i.e. if all face bounding boxes in previous image P have been processed relative to a current face bounding box in new image N), and if not returns to act 154. In act 170, if the answer is yes, processor 110 goes to act 171 and checks if the value of a flag stored in the variable overlapped is FALSE, and if not goes to act 174 (described above). If the answer in act 171 is that the variable overlapped is FALSE, processor 110 goes to act 172, wherein the bounding box of the face in the new image N of the current iteration is added (as a new face) to the set 221 of bounding boxes around regions indicative of occupancy C(k), followed by going to act 174. If the answer in act 171 is no, processor 110 goes to act 174.

In act 174, when the outer loop is completed, processor 110 goes to act 175, wherein the set 221 of bounding boxes around regions indicative of occupancy C(k), is stored in memory and/or output, for example for use in maintaining a set of counts corresponding to the set of regions. Some embodiments may thereafter perform an act 176, to initialize a next to-be-performed iteration of the method of FIG. 1C by use of the set 221 of bounding boxes around regions C(k) as the group of bounding boxes of faces P(i), which is then followed by performing act 142 on yet another new image (as described above), thereby to skip act 141.

In several aspects of described embodiments, one or more processor(s) 210 within a computer 200 that is mounted in a vehicle 299, may be programmed by software 222 in a non-transitory memory 220 (FIG. 2A) coupled thereto, to perform acts (or operations) 211-217. In performing acts 211-217, processor(s) 210 may maintain in the non-transitory memory 220, a set 221 of bounding boxes around one or more region(s) in a video that are indicative of one or more occupant(s) in vehicle 299, and a corresponding set 126 of counts, each count being associated with a corresponding region (which as just noted, is indicative of a corresponding occupant).

As illustrated in FIG. 2A, a region 224A in set 221 has associated therewith an occupant-specific count 225A in set 126, another region 224I in set 221 has associated therewith another occupant-specific count 225I in set 126, and still another region 224N in set 221 has associated therewith an occupant-specific count 225N in set 126. Specifically, memory 220 holds an association 226A, between a region 224A and an occupant-specific count 225A corresponding thereto. Association 226A may be implemented as a data structure in memory 220, e.g. by storing an identifier of region 224A and occupant-specific count 225A adjacent to one another. Each of regions 224A . . . 224I . . . 224N identifies in one or more frame(s) 223 in a video captured by camera 101 (FIG. 2A), a specific occupant inside an interior of vehicle 299. Regions 224A . . . 224I . . . 224N may be identified by any method of image processing of frame(s) 223. In some aspects of the several embodiments, region 224A may be identified in the form of a bounding box around a person's face in an image and/or in certain embodiments region 224N may be identified in the form of an occupied seat which does not overlap any face bounding box in the image, to account for those occupants whose faces are not detected by image processing e.g. due to occlusion or failure of face recognition.

After image processing, processor(s) 210 compute an overlap between region 224J in a current frame and region 224J in a previous frame, as per act 211 (FIG. 2A). Specifically, act 211 may be implemented in some embodiments, by identifying bounding boxes of faces that overlap one another in a current frame and a previous frame as discussed in reference to operation 140 (FIG. 1C), and additionally by performing a similar operation to identify bounding boxes of faces that overlap bounding boxes of seats. Thereafter, also in act 211 processor(s) 210 check whether a specific condition is satisfied by the overlap. The specific condition is designed to indicate that an occupant identified by region 224J is still within vehicle 299. When the overlap is greater than or equal to a limit, the specific condition is satisfied, and in this case processor(s) 210 may be configured to initialize to zero in act 212 (FIG. 2A), a second count 225J which is associated with second region 224J (whose overlap was checked in act 211). When the overlap is found to be less than the limit, the specific condition is not satisfied (which determines that the occupant is not detected, for any reason, in the current frame), and in this case processor(s) 210 may be configured to increment count 225J in act 213 (FIG. 2A), followed by checking whether count 225J exceeds a threshold 228 (e.g. expressed in number of frames).

A threshold check, as per act 214 (FIG. 2A), ensures that an occupant is not prematurely determined by processor(s) 210 to have left vehicle 299. More specifically, an occupant needs to remain undetected (or missing) at least a threshold number of times, before processor(s) 210 determine that the occupant is no longer in the vehicle. In some embodiments, only when the threshold is exceeded by occupant-specific count 225J do processor(s) 210 remove region 224J from set 221, as per act 214 (FIG. 2A). In some embodiments, the threshold is selectable from among two values, based on vehicle 299 being stationary or moving, e.g. as indicated by a signal from sensor 106. A low value of threshold T (e.g. 30 frames) may be used when the signal from sensor 106 indicates that vehicle 299 is stationary, because occupants are likely to be disembarking. A high value of threshold T (e.g. 150 frames) may be used in some embodiments when the signal from sensor 106 indicates that vehicle 299 is moving, based on an assumption that occupants do not normally disembark from vehicle 299 when vehicle 299 is in a moving state.

On completion of act 222 or 214 (described above), processor(s) 210 may perform an act 215 (FIG. 2A), to check if any region in set 221 has not been evaluated in a current iteration, and if yes, processor(s) 210 may return to act 211 (described above). When the answer is no in act 215, indicating that all regions in set 221 have been evaluated, processor(s) 210 may perform an act 216 (FIG. 2A), to update a display 103 which shows a number of bounding boxes in set 221 to a driver of vehicle 299, and/or to transmit this number to a server by use of a wireless transmitter 104 (FIG. 2A). Act 216 (FIG. 2A) may be followed by an act 217 in which processor(s) 210 check if one or more new frame(s) 223 have been received from camera 101, and if so return to act 211 (described above) to repeat the just-described acts and/or operations of zero setting (in act 212), count incrementing (in act 213), threshold checking and bounding box removal from set 221 (in act 214).

Although in the above-described embodiments, count 225J of region 224J is incremented and region 224J is removed from the set 221 when the occupant-specific count exceeds the threshold, alternative embodiments decrement the occupant-specific count and when the occupant-specific count falls below the threshold the corresponding bounding box is removed from the set 221 (which is indicative of occupants currently occupying seats).

In some embodiments, computer 200 (FIG. 2B) includes, in addition to wireless transmitter 104 described above, a wireless receiver 102 both of which are coupled to an antenna 109. In addition, computer 200 may include a clock 105 that may be used to clock each of transmitter 104, receiver 102 and processor(s) 210. Camera 101 and sensor 106 which are both included in computer 200 may be fixedly mounted in vehicle 299 (FIG. 2C) at locations that are physically separate from one another and also separate from a location of display 103 and a circuit board that contains processor 210 and memory 220 all of which may communicate with one another using wired or wireless interfaces, as illustrated in FIG. 2C. Processor(s) 210 (FIGS. 2B, 2C) may include an arithmetic logic unit (ALU) which may be programmed to count a number of regions in set 221 by execution of instructions in software 222 stored in memory 220 (FIG. 2A). As noted above, memory 220 is coupled to processor(s) 210 to receive and store one or more region(s) and corresponding count(s) in set 221.

In some embodiments, one or more processor(s) 210 may be configured to perform acts 301-319 of the type illustrated in FIG. 3A as follows. Specifically, processor(s) 210 start in act 301, initializes st (which represents set 221 described above) to an empty list in act 302. In embodiments of the type illustrated in FIG. 3A, st represents a current state of vehicle 299, and st is stored as a list of bounding boxes, based on a last frame of video that was completely processed. Thus, list “st” is an illustrative implementation of a set 221 of bounding boxes. Thereafter, in act 303, camera 101 is operated (FIG. 2B) to capture an image (also called “current frame” or “current image”), followed by act 304. In act 304, processor(s) 210 set bb to a list of bounding boxes that outline all faces detected in the current frame (captured in act 303). Thus, list “bb” is an illustrative implementation of a group of bounding boxes in the current image. In some embodiments of act 304, processor(s) 210 determine the (x, y) coordinates of each corner of a bounding box (which represents a region 224J, described above in reference to FIG. 2A) around a boundary of a human's face in a current frame.

Thereafter, in act 305 (FIG. 3A), processor(s) 210 set a looping variable i to zero, followed by act 306. In act 306, processor(s) 210 check if the variable i is less than the length of st (wherein, st as noted above, is a list of bounding boxes of occupants, e.g. based on the last T frames). Initially, list st is empty, and so when act 306 is entered from act 305, list st's length is zero, and so the answer is “no” in act 306 (because i is zero also). When the answer is no in act 306, processor(s) 210 go to act 307, wherein i is again set to zero, followed by act 308. In act 308, processor(s) 210 check if i is less than the length of list bb, and if the answer is yes act 309 is performed (e.g. initially, when there is even one bounding box in list bb). In act 309, processor(s) 210 copy a bounding box indexed by the value i in list bb to the end of list st, and go to act 310. In act 310, variable i is incremented, and processor(s) 210 return to act 308 (described above). When the answer in act 308 is no, then processor(s) 210 proceed to act 311 (FIG. 3A), wherein occupancy count is determined as a total number of bounding boxes in list st, also referred to as the length of list st, followed by returning to act 303 (described above). Occupancy count (also called “overall count”) is indicative of a current number of people detected in vehicle 299.

When the answer in act 306 is yes (e.g. when list st is not empty), then processor(s) 210 go to act 312. In act 312 (FIG. 3A), processor(s) 210 search through list bb for a bounding box in the current image, which has at least a predetermined percentage of overlap (e.g. 80%) with a prior image's bounding box (and/or a seat bounding box) indexed by the value i in list st. The prior image's bounding box at st[i] is also referred to as “current” bounding box. When such a bounding box exists in the current image (also called “overlapping bounding box”), the variable idx is set to that overlapping bounding box's index in the list bb. Alternatively, when no bounding box in the current image (i.e. in the list bb) has the predetermined percentage of overlap with the current bounding box at st[i], then the variable idx is set to a predetermined negative number, e.g. −1. Thereafter, processor(s) 210 go to act 313 to check if variable idx is negative and if the answer is yes, go to act 317.

In act 317(FIG. 3A), processor(s) 210 increment a count (e.g. count 225J in FIG. 2A) of frames in which the current bounding box at st[i] was not detected (due to no overlap in the current frame), as follows: f[i]=f[i]+1, followed by act 318. Accordingly, f is a list of consecutive missed frames, and the entry at position i in this list st indicates a count of consecutive frames over which a corresponding bounding box at position i in list st (i.e. the current bounding box) was not detected in list bb. Thus, relative to a current frame (identified by value 0), a last frame in which the current bounding box was most recently detected, is identified by f[i]. The index “i” in f refers to an individual bounding box in the list st. Thus, a bounding box's face region (or occupied seat region, depending on the embodiment) being detected in a current frame (due to overlap with a bounding box in a prior frame), is identified by f[i]'s value being zero. In act 318, processor(s) 210 check if the value f[i] exceeds threshold T, and if so then in act 319 the current bounding box at st[i] is removed from st, followed by act 316 in which variable i is incremented, followed by returning to act 306 (described above). A set of counts f[0]-f[n] that include “n” counts in number is maintained, as just described, for a threshold number of successive frames T, to account for temporary occlusion of bounding boxes, so that a bounding box may disappear from a current frame and re-appear in a later frame within threshold T frames, without changing its presence in list st (e.g. without changing how many counts “n” are maintained, in the set 126 of counts).

In act 318 (FIG. 3A), if the answer is no, processor(s) 210 go to act 316 directly (in which variable i is incremented followed by returning to act 206, as just described). In act 313 if idx is not negative, processor(s) 210 go to act 314. In act 314, processor(s) 210 overwrite one or more properties of the current bounding box at st[i], with corresponding properties of an overlapping bounding box in the current image at index idx in list bb. For example, coordinates of two diagonally opposite corners of the current bounding box are replaced with corresponding coordinates of two diagonally opposite corners of the overlapping bounding box. Also in act 314, f[i] is set to 1. In this manner, when an occupant in vehicle 299 moves, a new location of their face in the current frame gets stored in list st. Then, in act 315, processor(s) 210 remove the overlapping bounding box at index idx in list bb, followed by act 316 (described above).

In some embodiments, processor(s) 210 may be configured to select threshold T by performing acts 321-325 as illustrated in FIG. 3B, as follows. Specifically, processor(s) 210 start in act 321, followed by act 322 to check whether the vehicle (e.g. a bus) is currently in motion (e.g. as indicated by sensor 106 in FIG. 2A). If the answer in act 322 is yes, then processor(s) perform act 325 by setting the threshold T to 5 seconds (or 150 frames when a video captured by camera 101 has a rate of 30 frames per second). When the answer in act 322 is no, then processor(s) perform act 323 by setting the threshold T to 1 second (e.g. 30 frames). After act 323 or act 325, processor(s) 210 reach act 324 where this procedure waits for a specific duration which is preset (e.g. 30 seconds) followed by returning to act 322 (described above). Hence, threshold T is periodically updated, depending on a state of motion of the vehicle.

Computer 200 of some embodiments is configured in a training phase 330 (FIG. 3C) to perform acts 331-333. Training phase 330 is followed by normal operation 334 which implements two counter operations, namely face counter operation 340 and seat counter operation 350 to determine occupancy in vehicle 299 (FIG. 2A). In training phase 330, camera 101 is operated in act 331 when vehicle 299 is unoccupied, to obtain an image in which no regions indicate an occupant, such as image 401 (FIG. 4A). Thereafter, image 401 is processed in act 332 to detect edges therein, as illustrated by image 402 in FIG. 4B. Subsequently, in an act 333, the edges in image 402 are classified, by application of a classifier (which is trained on seat boundaries) to the edges detected in act 332, e.g. to identify coordinates of bounding boxes 411-421 (FIG. 4C). These bounding boxes 411-421, which are formed by the classifier around boundaries of unoccupied seats in vehicle 299, are stored in memory 120, identified by (x, y) coordinates 411D . . . 413D of two diagonally opposite corners (e.g. top right and bottom left) of each bounding box, as illustrated respectively for bounding boxes 411 and 413 in FIG. 4D.

Subsequently, in normal operation 334, camera 101 is operated to capture an image in an act 335 (hereinafter “current image”), followed by acts 311-316 in face counter operation 340. In act 341, computer 200 applies face detection to the current image, to identify one or more faces of occupants in vehicle 299. Thereafter, in act 342, computer 200 checks if a bounding box around a face, undetected in a previous frame, now detected in a current frame, by checking a predetermined overlap condition between bounding boxes in these two frames (e.g. more than 70% overlap along each of two coordinate axes, namely x-axis and y-axis). If the answer in act 342 is yes, then computer 200 performs acts 343 and 344 followed by going to act 345. If the answer in act 342 is no, computer 200 goes to act 345 (without performing acts 343 and 344).

In act 343, for each bounding box around a face detected in current image and undetected in any of T prior images, computer 200 initializes the corresponding count f[i] to 1 (e.g. as per act 314 in FIG. 3A, described above). Act 343 is performed repeatedly, once for each newly detected bounding box surrounding a face. Hence, when one or more faces are newly detected in a current image, a set 221 indicative of occupancy in the vehicle 299, is increased by addition of one or more newly-detected face-surrounding bounding box(es), as shown by act 344 in FIG. 3C (e.g. as per act 309 in FIG. 3A, described above). Act 344 may be performed multiple times (repeatedly for each face-surrounding bounding box detected in current image and undetected in any of T prior images as per act 343). Then, in act 345, computer 200 checks if any face which was identified in one of T prior images (e.g. by a bounding box in set 221 of FIG. 2A) has not been detected (by its overlap with any bounding box) in the current image. In some embodiments, T is an automatically-selectable number of frames, e.g. 30 frames when the vehicle is stationary or 150 frames when the vehicle is in motion. If the answer is no in act 345, rest of face counter operation 340 is skipped, and computer 200 goes directly to seat counter operation 350 (described below).

When there are one or more faces-surrounding bounding boxes which are undetected in the current image, although previously detected in one of T prior images, then act 346 is performed. In act 346 of FIG. 3C, for any face-surrounding bounding box which is undetected in current image but detected in one of T prior images, count f[i] is incremented (e.g. as per act 317 in FIG. 3A, described above). As described above, f[i] is a count of a number of times that the bounding box of a region 224J (FIG. 2A) could not be detected in a current image. Act 346 in FIG. 3C is repeated, for each bounding box indexed by variable i and identified in a prior image (in set 221 in FIG. 2A). Then, in act 347, computer 200 selects a threshold T based on whether vehicle 299 is stationary or moving, as illustrated in FIG. 3B (described above). Subsequently, in act 348, computer 200 checks if threshold T is greater than count f[i] and if not goes to operation 350 (e.g. as per act 318 in FIG. 3A, described above). When threshold T is exceeded by any count f[i], then set 221 (FIG. 2A) which indicates occupancy is reduced in act 349, by removal of the bounding box surrounding a current face (e.g. as per act 319 in FIG. 3A, described above). Act 348 of FIG. 3C is repeated for each bounding box indexed by variable i, and identified in a prior image (e.g. in set 221). Act 349 may be performed multiple times: once for each face-surrounding bounding box undetected in current image but detected in any one of T prior images as per act 346. When all bounding boxes of faces in set 221 have been processed, face counter operation 340 is completed, followed by seat counter operation 350.

Seat counter operation 350 is similar or identical to face counter operation 340, except that instead of using faces to identify bounding boxes, one or more seats which are occupied are used to identify seat-surrounding bounding boxes in the current frame, wherein pixels have colors which are different relative to original colors of pixels in corresponding bounding boxes 411-421 (FIG. 4C, described above). More specifically, in act 351, computer 200 performs background subtraction, for each bounding box around a seat (also called seat-surrounding bounding box) in the current image that does not overlap a bounding box around a face (also called face-surrounding bounding box) in the current image (as identified in act 341), thereby to identify occupied seats in the current image. Thereafter, in act 352, computer 200 checks if any seat determined to be occupied in one of the T prior images is not occupied in the current image. Hence, act 352 of some embodiments checks whether a new bounding box (which is identified in the current image based on coordinates of bounding boxes of empty seats identified during training), is currently unoccupied based at least on performing background subtraction on the new bounding box in the current image. When the answer is no in act 352, computer 200 performs an operation 359 to add seats to occupancy set 221 when needed, then performs act 311 and returns to act 335 (described above). When the answer is yes in act 352, computer 200 goes to act 353.

In act 353, for each seat that is not occupied in the current image, but which was occupied in one of the T prior images (and is therefore present in set 221), computer 200 increments count f[i], which represents a number of times that this seat (“current seat”) has been found unoccupied. Act 353 is repeated, for each seat bounding box indexed by variable i and identified in a prior image (in set 221 in FIG. 2A), which is currently not occupied. Then, computer 200 performs act 355, to check if threshold T is greater than count f[i] and if not performs operation 359 to add seats to occupancy set 221 when needed and then goes to act 335. When threshold T is exceeded by any count f[i], then set 221 (FIG. 2A) which indicates occupancy is reduced in act 356, by removal of the current seat from occupancy set 221. Act 355 is repeated for each seat bounding box indexed by variable i, and identified in a prior image (e.g. in set 221). When all seat-surrounding bounding boxes in set 221 have been processed, seat counter operation 350 performs an operation 359 to add seat-surrounding bounding boxes to occupancy set 221 when needed, which is then followed by act 311 and act 335 (described above).

In some embodiments, operation 360 (FIG. 3D) includes an act 362 to check if a seat previously unoccupied is now occupied and if so go to act 363. In act 363 such embodiments may increment a count g[k], for each seat-surrounding bounding box which is found to be occupied in the current image but was unoccupied in one of T prior images, followed by act 364 to check if threshold T is exceeded by any count g[k] and if so increasing set 221 by adding that bounding box in act 365. These acts may be similar to acts 342, 343 and 344 (described above in reference to face counter 340). Acts 363 and 364 may be skipped in some embodiments, as shown by branch 366 whereby control transfers from the no branch of act 362 directly to act 365 (both described above). When the answer is no in act 362, as well as when act 365 is completed, control transfers to act 335 (FIG. 3C), so that a new image is captured for processing as described above.

Thus, several aspects of the described embodiments use multiple camera frames over time, as well as optional GPS, accelerometer, and gyroscope data to determine the number of occupants in a vehicle 299, such as a bus.

Some methods of the type illustrated in FIGS. 1A, 1B, 2A, 3A-3B and 3C (described above) are executed locally within a housing that includes camera 101, which enables a processor 210 therein to provide a continuous and accurate count of a number of occupants and vacant seats in vehicle 299, without a connection to the Internet. Eliminating an Internet connection by methods of the type illustrated in FIGS. 1A, 1B, 2A, 3A-3B and 3C as described herein is desirable from a mobile bandwidth, power, and privacy standpoint. Moreover, some methods of the type illustrated in FIGS. 1A, 1B, 2A, 3A-3B and 3C are less subject to drift from over-counts or under-counts of a true passenger count, when passengers are entering or exiting vehicle 299.

In some aspects of methods of the type illustrated in FIG. 3C the seating capacity and occupancy count may be determined automatically, without user input of configuration information from an operator of vehicle 299, by use of training phase 330. Specifically, background subtraction is used in some embodiments of the type illustrated in FIG. 3C to determine the foreground of an image by analyzing multiple images of interior of vehicle 299 which are captured over time, to determine areas in the scene that have changed. In the just-described multiple images, a view within windows of vehicle 299 changes, due to activity outside of vehicle 299. This outside activity is irrelevant to the occupancy detection problem being solved by computer 200. More specifically, background subtraction in computer 200 may falsely identify as areas of interest, one or more areas (such as within-window areas) which are unrelated to occupancy detection. By training computer 200 to initially identify coordinates of seats in training phase 300, non-essential areas of a current image captured in act 335 (FIG. 3C) are automatically filtered out (or automatically ignored), even though foreground changes in those areas may be identified (e.g. by performance of background subtraction on an image as a whole, in its entirety).

In some aspects of methods of the type illustrated in FIG. 3C, multiple computer vision approaches are used. Specifically, by training computer 200 to identify seats before counting passengers, a frame of reference is provided, to use two separate computer vision methods to augment each other (e.g. face counter operation 310, followed by seat counter operation 350 of FIG. 3C), without double-counting occupants. In some embodiments, background subtraction in seat counter operation 320, and face detection in face counter operation 340 both process an entire camera frame, and the size/coordinates of each seat is used to determine if the same seat has already been determined to be occupied.

Several aspects of the described embodiments use a signal from a sensor 106, such as GPS and/or accelerometer and/or vehicle's door(s) open, to determine whether vehicle 299 is in a state of motion (also called “moving state”) or alternatively in a state of being stationary (also called “stationary state”). Such embodiments apply a criterion that occupants may only enter or leave a vehicle 299 when the vehicle is stopped, e.g. by selecting a low value for threshold T. When vehicle 299 is in a moving state, face detection and background subtraction in operations 340 and 350 may temporarily fail, because people may be occluded (e.g., behind support rods, looking out the window, bending over). In this situation, the signal from sensor 106 determines that vehicle 299 is in a moving state, and thus occupancy count (e.g. number of regions in set 221) is not reduced, even when temporary occlusions occur (e.g. occlusions in successive images fewer than threshold T do not change occupancy).

In embodiments wherein map data is provided to electronic device 100, GPS is used to differentiate between vehicle 299 being stopped at a place where passengers may enter and exit, versus vehicle 299 being stopped for other reasons (e.g., red light, stop sign, traffic). More specifically, when vehicle 299 is stopped for other reasons (not a place where passengers exit and enter), the state of vehicle 299 is set to moving in act 322 (FIG. 3B), which is thus followed by act 325 (even though vehicle 299 is stationary).

In some embodiments, when computer 200 is first powered on, it enters a training phase 330 (FIG. 3C). Training phase 330 is used to identify seats to determine the capacity of vehicle 299. Once seat coordinates are identified, they are stored in nonvolatile memory 220, and computer 200 proceeds to normal operation 334 (FIG. 3C). During normal operation 334, seat coordinates identified in training phase 330 are used to detect when a particular seat is occupied. Computer 200 may be programmed to skip training phase 330 at subsequent power cycles, unless it is moved to another vehicle, or seating arrangements are changed.

Some embodiments identify the coordinates of each seat in vehicle 299, as illustrated in FIGS. 4A-4D (note that the images and data are only examples). Specifically, when computer 200 enters training phase 330, it captures an image from the camera 101. It is assumed the vehicle 299 is not occupied with passengers (e.g. because bus drivers typically are alone when they start the vehicle). Thereafter, in act 332 (described above), this image is passed through a Sobel filter to detect the edges of the seats (although Canny filter may be used alternatively for edge detection for identifying seats). The Sobel filter is used in act 332 of some embodiments, due to more robust edges found by experimentation on sample images.

After the edges of seats have been detected in act 332, some embodiments of computer 200 are programmed to use a classifier, e.g. Histogram of Oriented Gradients (HOG) with Support Vector Machines (SVM) or a Haar classifier, along with a pre-trained database of seat images to determine the number and coordinates of each seat in the image frame. Once this seating information is determined in act 333 (FIG. 3C), the seat count is stored in nonvolatile memory, along with polygonal coordinates that define the boundary of each seat. This process, which is performed in act 333, is also called seat marking, because it marks a region around each seat to be identified during normal operation. After marking all the seats (object of interest), the information about all the training positive images is stored in nonvolatile RAM. This information is used as input while training a classifier in act 333. Once the model is generated using the descriptor and a set of negative images, subsequent cycles can skip the training phase 330.

Once a count of how many seats are present and their coordinates are determined by training phase 330, computer 200 is programmed to perform normal operation 334 based on the seating capacity of the vehicle (for very long bus configurations, additional enhancement(s) may be used, e.g. seat counter operation 350). Specifically, during normal operation 334, some embodiments of computer 200 determine the number of occupants in the bus using two separate approaches (note that the images and data are only examples), namely face counting in operation 340 which is enhanced by seat counting in operation 350. In seat counting operation 350, seat coordinates which are determined during training phase 330 are used in operation 350 in act 351. Thus, some embodiments of seat counter operation 350 (FIG. 3C) may identify seats which are overlapped by faces, by checking for overlap between two types of bounding boxes, namely first bounding boxes identified by coordinates of seats (also called seat bounding boxes), and second bounding boxes identified by coordinates of faces (also called face bounding boxes).

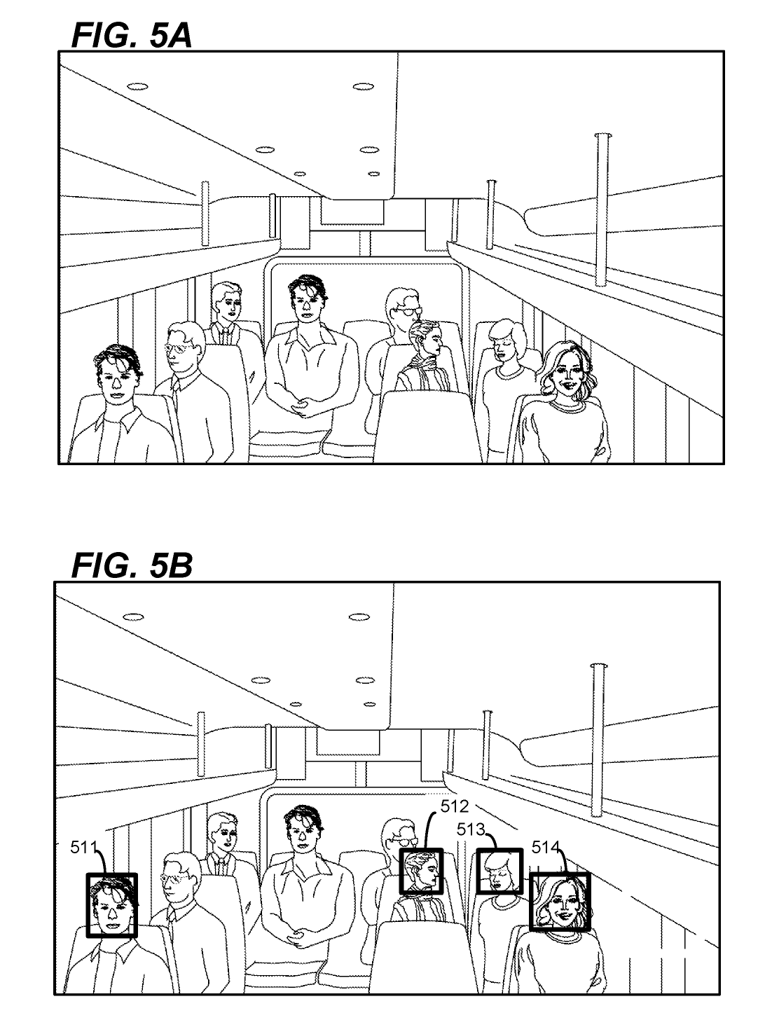

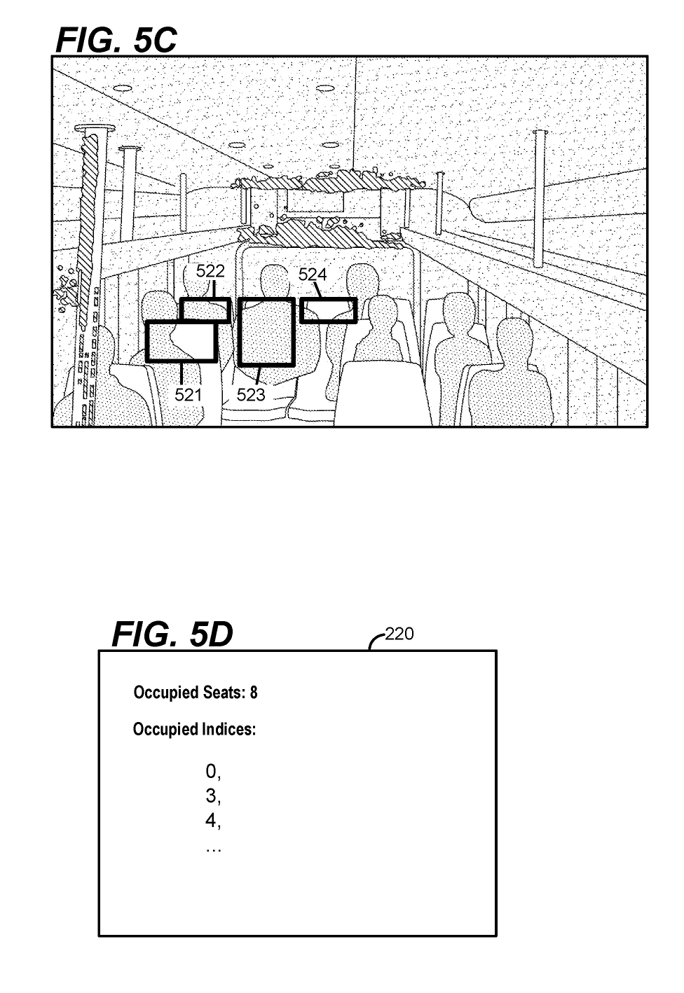

In FIGS. 5A and 5B, images containing faces may be pixelated, to preserve individuals' privacy, although several embodiments of computer 200 may not blur faces, when no images are transmitted outside of vehicle 299. During normal operation 334 of some embodiments, computer 200 sets a free seat count initially to a capacity of the bus, and each face detected causes the free seat count to be deducted by 1. Since faces may not reliably be detected due to occlusions, camera angles, and lighting variations, computer 200 may be programmed to augment the face detection over time, to maintain the free seat count unchanged even when a face is not detected for several frames. In some embodiments, computer 200 is programmed to consider a person not to be out of the vehicle 299, until that person had failed to be detected for 30 frames (e.g. T=1 second, or 30 frames). FIG. 5B shows the result of act 341 (FIG. 3C) in a face counter operation 340 performed by electronic device 100, wherein four bounding boxes 511-514 are identified in a current frame.

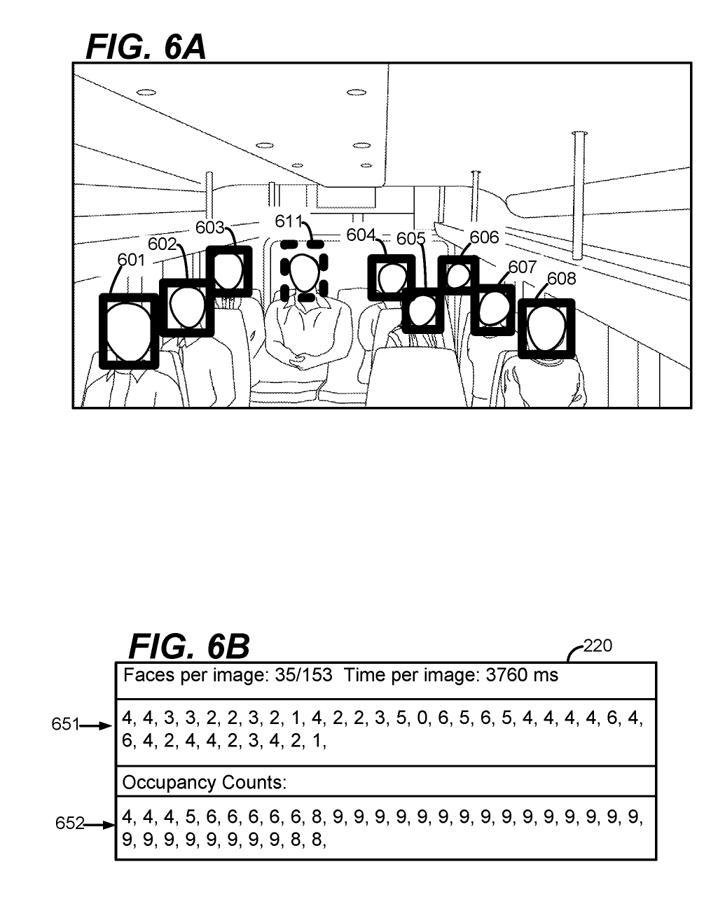

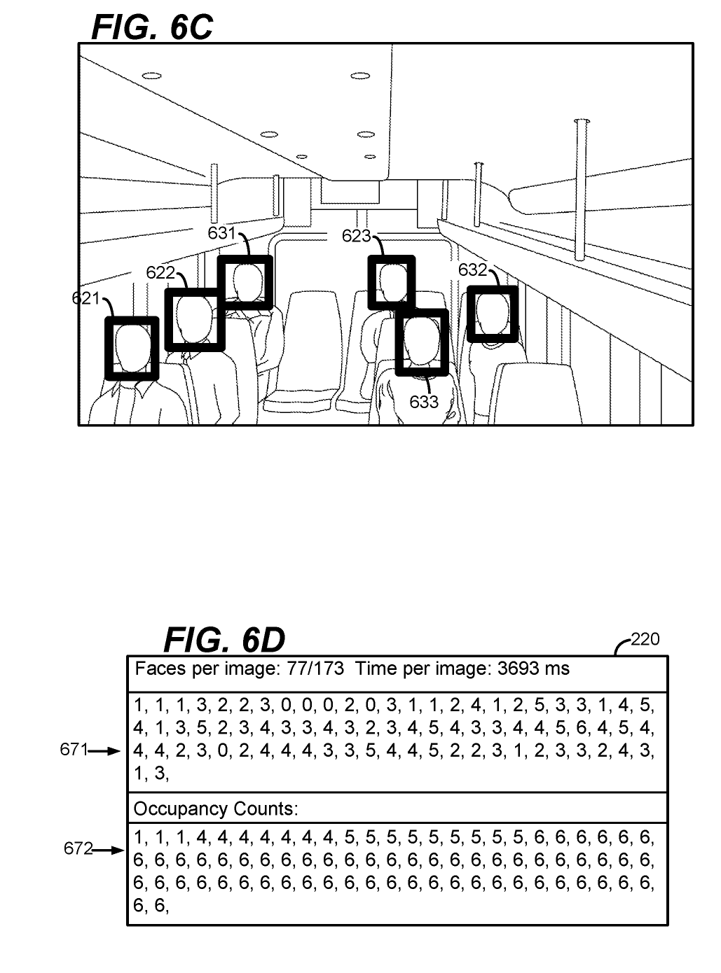

Face counter operation 340 may be enhanced in some embodiments by performing multiple passes, e.g. as shown by bounding boxes 601-608 in FIG. 6A and bounding boxes 621-623 in FIG. 6C, which indicate faces that were detected in a current frame. In addition, box 611 in FIG. 6A and bounding boxes 631-633 in FIG. 6C indicate faces not detected in a current frame, but included because they were detected in the last 30 frames. The images in FIGS. 6A and 6C are obtained by running a four-pass version of the above-described face counter operation 340 of FIG. 3C, by analyzing a single frame from camera 101, at four different scale levels. Specifically, one four-pass version of face counter operation 340 performs a first pass on a frame as initially captured, and then reduces the scale level (e.g. by 2) for each of the remaining three passes. Unique faces are automatically counted by computer 200 from each of these four passes, to obtain a final number of faces. FIG. 6A shows faces identified by a four-pass version, and FIG. 6B shows reports thereof, based on bounding boxes of faces in set 221 in memory 220.

Specifically, FIG. 6B shows examples of two types of results as follows. List 651 shows a temporal sequence of counts of face detection in an image, e.g. each number identifies a number of faces detected in each frame of a video. List 652 shows a temporal sequence of counts indicative of occupancy, e.g. each number identifies a number of occupants determined based on faces detected in a current frame and faces detected in one or more prior frames, by performing a method of the type illustrated FIGS. 1A-1C. Similarly, FIG. 6C shows faces identified by a four-pass version, and FIG. 6D shows reports thereof (similar to FIG. 6B) based respectively on face detection (wherein list 671 is a temporal sequence of face counts), and use of the method of FIGS. 1A-1C (wherein list 672 is a temporal sequence of occupancy counts).

In some embodiments, computer 200 includes, in addition to camera 101, one or more sensor(s) 106, such as an accelerometer and/or gyroscope. These sensors' information is used to reject person omissions, when vehicle 299 is in a state of motion. Specifically, when face detection in act 341 fails to detect a person but vehicle 299 is in the moving state of (as evidenced by a signal from sensor 106), then computer 200 is configured to maintain count f[i] in operation 340, even though a corresponding bounding box of a face is not detected in a current frame. Additionally, in some embodiments, the accelerometer and gyroscope are used to determine the mounting angle of camera 101. This problem has a known solution using the Extended Kalman Filter (EKF). This information is useful in determining perspective information for longer buses. As shown in FIG. 2C, mounting angle 291 is estimated, e.g. by use of sensor data and/or manually determined by measuring with a protractor.

One test setup was on 20′ long shuttle buses, although most buses in the United States are 40′ long. As a result, it is likely that some passengers towards the back of a bus would be occluded or too small for the face detection approach to work, so a seat counter operation 350 is additionally used to augment face counter operation 340. Hence, in some embodiments, after performing face counter operation 340 for a current frame, a seat counter operation 350 is performed based on background subtraction, to detect occupancy of seats by individuals whose faces cannot clearly be seen. Seat counter operation 350 uses coordinates of seats (obtained in training phase 330), to determine when a seat is occupied. In performing act 351 (FIG. 3C), when a predetermined number (or percentage) of foreground pixels are determined to be present in a seat bounding box, that seat is determined to be occupied. For example, seat bounding boxes 521-524 in FIG. 5C are identified as being occupied, by use of background subtraction on the image of FIG. 5A.

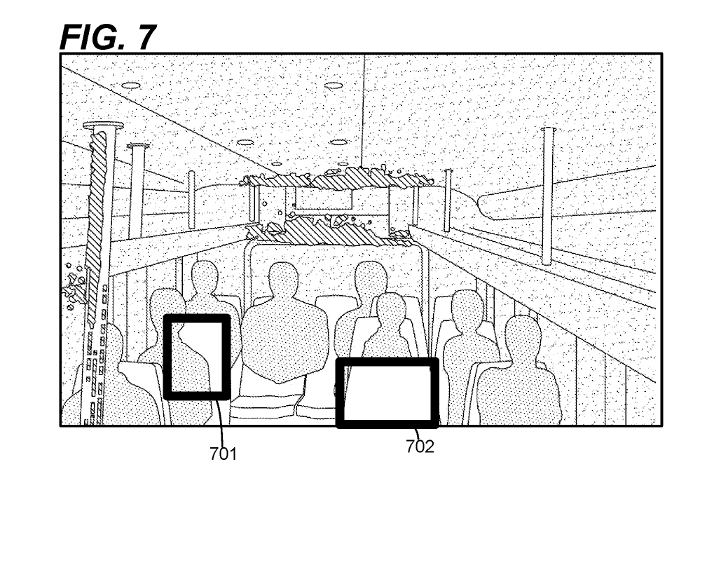

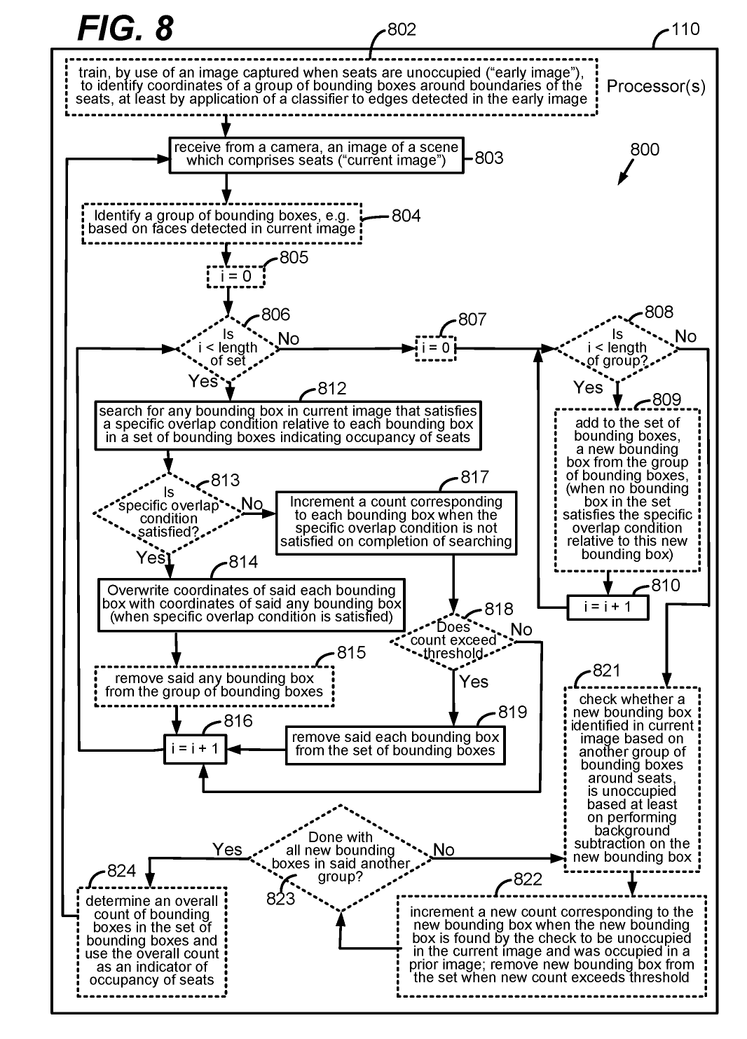

Based on the size and location of a region of detected foreground, the occupancy count may be incremented accordingly, e.g. as illustrated in acts 352 and 353. The seat coordinate information is used in act 351 to ensure that seats that were determined to be occupied by face counter operation 340 (FIG. 3C) are not counted again using background subtraction (in act 353). More specifically, in a sample image shown in FIG. 7, detected foreground is shown in grey and the background is shown in black. The size and (x, y) coordinates of each foreground section are used by computer 200 to automatically determine which seats are occupied. In FIG. 7, seat bounding box 701 has a foreground-background pixel ratio that exceeds a predetermined limit (e.g. 50%) which is used to determine if a seat is occupied, and seat bounding box 702 shows a seat which does not exceed the predetermined limit and hence is classified as ‘empty’.

For very long buses or buses with multiple levels, multiple cameras could be deployed. In this context, it is desirable for the cameras to be networked (e.g., over Wi-Fi) so a single occupancy and capacity count can be provided for the entire bus. Under this approach, it is desirable to identify landmark features in each frame that would allow the cameras to understand if a person has already been accounted for in another camera's count. For example, face detection can be enhanced to identify individual faces, and that information can be used to stitch together multiple images into a single frame to be analyzed. Alternatively, other feature points such as exit signs, guardrails, or posters could be used as landmarks to enable frame stitching across multiple cameras.

Depending on the aspect of the described embodiments, computer 200 of the type described above may be included in any mobile station (MS), of the type described herein. As used herein, a mobile station (MS) refers to a device such as a cellular or other wireless communication device (e.g. cell phone), personal communication system (PCS) device, personal navigation device (PND), Personal Information Manager (PIM), Personal Digital Assistant (PDA), laptop or other suitable mobile device which is capable of receiving wireless communications. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND.

Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server computer, or at another device associated with the network. Any operable combination of the above are also considered a “mobile station.” The terms “mobile station” and “mobile device” are often used interchangeably. Personal Information Managers (PIMs) and Personal Digital Assistants (PDAs) which are capable of receiving wireless communications. Note that in some aspects of the described embodiments, such a mobile station is equipped with a network listening module (NLM) configured to use PRS signals to perform TOA measurements that are then transmitted to a location computer (not shown).

The methodologies described herein in reference to any one or more of FIGS. 1A, 1B, 2A, 3A, 3B and 3C may be implemented by various means in hardware, depending upon the application. For example, these methodologies may be implemented in hardware, firmware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any non-transitory machine readable medium tangibly embodying instructions (e.g. in binary) may be used in implementing the methodologies described herein. For example, computer instructions (in the form of software) may be stored in a memory 220 (FIGS. 1A, 1B, 2A) of an electronic device 100, and executed by processor(s) 210, for example a microprocessor. Memory 220 (FIGS. 1A, 1B, 2B) may be implemented within a single chip that includes processor 210 or external to the chip that contains processor 210. As used herein the term “memory” refers to any type of long term, short term, volatile (e.g. DRAM), nonvolatile (e.g. SRAM), or other memory accessible by processor 210, and is not to be limited to any particular type of memory or number of memories, or type of media upon which memory is stored.

If implemented in firmware and/or software, functions of the type described above may be stored as one or more instructions or code on a non-transitory computer-readable storage medium. Examples include non-transitory computer-readable storage media encoded with a data structure and non-transitory computer-readable storage media encoded with a computer program. Non-transitory computer-readable storage media may take the form of an article of manufacture. Non-transitory computer-readable storage media includes any physical computer storage media that can be accessed by a computer.

By way of example, and not limitation, such non-transitory computer-readable storage media can comprise SRAM, ROM, EEPROM, CD-ROM or other optical disk storage, magnetic disk storage or other magnetic storage devices, or any other non-transitory medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Moreover, techniques used by computer 200 may be used for various wireless communication networks such a wireless local area network (WLAN), a wireless personal area network (WPAN), and so on. The term “network” and “system” are often used interchangeably. A WLAN may be an IEEE 802.11x network, and a WPAN may be a Bluetooth network, an IEEE 802.15x, or some other type of network. The techniques may also be used for any combination of WLAN and/or WPAN. The described embodiments may be implemented in conjunction with Wi-Fi/WLAN or other wireless networks. In addition to Wi-Fi/WLAN signals, a wireless/mobile station may also receive signals from satellites, which may be from a Global Positioning System (GPS), Galileo, GLONASS, NAVSTAR, QZSS, a system that uses satellites from a combination of these systems, or any SPS developed in the future, each referred to generally herein as a Satellite Positioning System (SPS) or GNSS (Global Navigation Satellite System).

This disclosure includes example embodiments; however, other implementations can be used. Designation that something is “optimized,” “required” or other designation does not indicate that the current disclosure applies only to systems that are optimized, or systems in which the “required” elements are present (or other limitation due to other designations). These designations refer only to the particular described implementation. Of course, many implementations of a method and system described herein are possible depending on the aspect of the described embodiments. The techniques can be used with protocols other than those discussed herein, including protocols that are in development or to be developed.

“Instructions” as referred to herein include expressions which represent one or more logical operations. For example, instructions may be “machine-readable” by being interpretable by a machine (in one or more processors) for executing one or more operations on one or more data objects. However, this is merely an example of instructions and claimed subject matter is not limited in this respect. In another example, instructions as referred to herein may relate to encoded commands which are executable by a processing circuit (or processor) having a command set which includes the encoded commands Such an instruction may be encoded in the form of a machine language understood by the processing circuit. Again, these are merely examples of an instruction and claimed subject matter is not limited in this respect.

In several aspects of the described embodiments, a non-transitory computer-readable storage medium is capable of maintaining expressions which are perceivable by one or more machines. For example, a non-transitory computer-readable storage medium may comprise one or more storage devices for storing machine-readable instructions and/or information. Such storage devices may comprise any one of several non-transitory storage media types including, for example, magnetic, optical or semiconductor storage media. Such storage devices may also comprise any type of long term, short term, volatile or non-volatile devices memory devices. However, these are merely examples of a non-volatile computer-readable storage medium and claimed subject matter is not limited in these respects.

Unless specifically stated otherwise, as apparent from the following discussion, it is appreciated that throughout this specification discussions utilizing terms such as “processing,” “computing,” “calculating,” “selecting,” “forming,” “enabling,” “inhibiting,” “locating,” “terminating,” “identifying,” “initiating,” “detecting,” “solving”, “obtaining,” “hosting,” “maintaining,” “representing,” “estimating,” “reducing,” “associating,” “receiving,” “transmitting,” “determining,” “storing” and/or the like refer to the actions and/or processes that may be performed by a computing platform, such as a computer or a similar electronic computing device, that manipulates and/or transforms data represented as physical electronic and/or magnetic quantities and/or other physical quantities within the computing platform's processors, memories, registers, and/or other information storage, transmission, reception and/or display devices. Such actions and/or processes may be executed by a computing platform under the control of machine (or computer) readable instructions stored in a non-transitory computer-readable storage medium, for example. Such machine (or computer) readable instructions may comprise, for example, software or firmware stored in a non-transitory computer-readable storage medium included as part of a computing platform (e.g., included as part of a processing circuit or external to such a processing circuit). Further, unless specifically stated otherwise, a process described herein, with reference to flow diagrams or otherwise, may also be executed and/or controlled, in whole or in part, by such a computing platform.

In some embodiments of the type illustrated in FIG. 3A, data in certain storage elements in a non-transitory memory used by processor 210 have the following meanings: list st denotes a current state, which is stored as a list of bounding boxes for the last frame that was completely processed, list bb denotes a list of bounding boxes outlining all faces seen in the current frame, and f denotes a list of consecutive missed frames. In list f, an entry at position i indicates the number of consecutive frames since the face at position i was last detected in list bb. Moreover, variable OccupancyCount denotes a current number of occupants detected, which is output by processor 210. A bounding box may be defined by processor 210, by x-and y-coordinates of the bounding box's top-left and bottom-right corners, which are stored in memory 220.

In several aspects of described embodiments, occupancy in a vehicle 299 which is used in a mass transit system (e.g. a bus, an airplane, or a coach of a train) is determined automatically, by maintaining in memory 220, a set of regions that indicate the vehicle's occupants in a video, across multiple frames therein. In each frame, a region that is indicative of an occupant of vehicle 299 can be a bounding box around a person's face, and/or a bounding box around an occupied seat. For each such region that indicates an occupant, a count 225J is maintained in memory 220 which is specific to a corresponding region 224J. Each bounding box's count may be repeatedly set to zero, as long as an overlap between the bounding box in a current frame and an adjacent bounding box in a previous frame, satisfies a specific overlap condition (e.g. because the occupant is still in vehicle 299). Whenever the overlap does not satisfy the specific overlap condition that bounding box's count is incremented (e.g. to indicate a number of times this occupant has not been detected). After incrementing, the bounding box's count is checked against a threshold T which is dynamically selected (e.g. based on whether vehicle 299 is moving or stationary).

Depending on the embodiment, threshold T may be selectable from among two values, based on whether vehicle 299 is stationary or moving. When an occupant region's count exceeds the threshold, that occupant region is removed from the set 221 of occupant regions (e.g. so as to determine the occupant is no longer in vehicle 299). The above-described operations of repeated zero setting, count incrementing, threshold checking, and removal from set 221 are repeated in some embodiments, for multiple regions in a video frame which are indicative of corresponding occupants (e.g. faces and/or seats). A count of the number of occupant regions which are currently in a set 221 may indicate occupancy and may be displayed (as a last count, shown in list 652 of FIG. 6B), e.g. in vehicle 299 and/or transmitted to a server (e.g. for issuing tickets, to board vehicle 299).

In certain embodiments, a method automatically determines occupancy, by performing one or more of the following acts (illustrated in FIG. 8). Specifically, in an act 803, the method automatically receives from a camera, an image of a scene comprising a plurality of seats. Subsequently, the method enters a loop for each bounding box in a set of bounding boxes previously identified in memory, by one or more processors (which are coupled to the camera) performing acts 812 (searching), 814 (overwriting), 817 (incrementing), and 819 (removing), as follows.

In act 812, the one or more processors search for any bounding box in the image that satisfies a specific overlap condition relative to said each bounding box in the set of bounding boxes. In act 814, the one or more processors overwrite coordinates of said each bounding box with coordinates of said any bounding box, when the specific overlap condition is satisfied. In act 817, the one or more processors increment a count corresponding to said each bounding box when the specific overlap condition is not satisfied on completion of said searching.

In act 819, the one or more processors remove said each bounding box from the set of bounding boxes when the count corresponding to said each bounding box exceeds a threshold. Depending on the embodiment, the threshold may be selected from among multiple thresholds based on a signal from a sensor, the signal being indicative of whether a vehicle in which the seats are mounted is stationary or moving (e.g. as described in reference to FIG. 3B).

In certain embodiments, in addition to the above-described acts 812, 814, 817 and 819, one or more processors may be configured to perform additional acts, e.g. act 824 to determine an overall count of bounding boxes in the set of bounding boxes and use said overall count as an indicator of occupancy of the plurality of seats.

In some embodiments, before performing the above-described act 812, the one or more processors may perform an act 804 to identify a group of bounding boxes (e.g. based on faces of occupants of seats) in the current image received in act 803, and then the searching in act 812 is performed through this group of bounding boxes.

Moreover, in such embodiments, before act 803, one or more processors may initially perform a training operation 802. In training operation 802, the one or more processors may use an earlier image captured when the seats were unoccupied, to identify coordinates of an initial group of bounding boxes of the seats, at least by application of a classifier to edges detected in said earlier image.

Depending on the embodiment, in addition to acts 812, 817, 814 and 819 over which method 800 of FIG. 8 enters a loop for each bounding box in a set of bounding boxes previously identified in memory, the method may include additional acts within the loop itself, such as act 813 (wherein a check is made as to whether a specific overlap condition is satisfied), act 818 (wherein another check is made as to whether the count exceeds threshold), and act 816 (wherein a looping variable “i” is incremented). In some embodiments, an act 815 may be performed (e.g. before act 816), to remove any bounding box from the group of bounding boxes, when the specific overlap condition is satisfied (e.g. after said any bounding box is used in the overwriting of act 814).

Moreover, in certain embodiments, an act 805 at the beginning of such a method may set the looping variable “I” to zero initially, followed by act 806 to check if the value if variable “i” is less than a length of the set of bounding boxes (which may change during any one or more iterations in the loop, as looping variable “i” increments). Looping completes when the looping variable “i” becomes greater than or equal to the length of the set of bounding boxes, after which time an act 807 may be performed to set variable “i” to zero for use in another loop implemented by acts 808-810 (described below). Note that instead of variable “i” another variable “j” may be used in act 807 and in the loop of acts 808-810.

In some embodiments, in act 808, method 800 checks if the length of the group (which is initially identified in act 804 and updated by repeated performance of act 815) is greater than the value of variable “i” and if not goes to act 821 (described below). When the variable “i” is less than the length of the group, then method 800 performs act 809. In act 809, method 800 adds to the set of bounding boxes (which is updated in act 814 or act 819 in the previously-described looping over acts 812-819), a new bounding box from the group (when no bounding box in the set satisfies the specific overlap condition, relative to this new bounding box), followed by act 810 of incrementing the variable “i” followed by returning to act 808. Hence, in this manner, by looping over act 809, all the new bounding boxes in the group of bounding boxes, which were previously not present in the set are added to the set, after which act 821 is performed.

In act 821, the method 800 checks whether a new bounding box is unoccupied, with this new bounding box being identified in the current image among another group of bounding boxes (also called “seat counter” group). The seat counter group of bounding boxes may be identified based on boundaries of seats, e.g. recognized by a classifier in act 802 by edge detection of an early image of unoccupied seats. In some embodiments of act 821, occupancy of the just-described new bounding box (which is identified based on seat boundaries in the early image) may be determined by performing background subtraction, on pixels of a current image within the just-described new bounding box.

When the just-described new bounding box is found to be unoccupied in the current image, but was occupied in a prior image then a new count corresponding to the just-described new bounding box is incremented. When the just-described new bounding box is found to be occupied in the current image, but was unoccupied in a prior image, the just-described new bounding box may be added to the set of bounding boxes (with or without a delay based on threshold, depending on the embodiment). Moreover, in act 822, the just-described new bounding box is removed from a set of bounding boxes, when the new count exceeds the threshold. Act 822 is followed by act 823 to determine if all new bounding boxes in said another group have been checked for occupancy, and if not method 800 returns to act 821 to determine occupancy of another new bounding box in said another group. When the answer in act 823 is yes, because all new bounding boxes in the seat counter group have been processed, then method 800 performs an act 824, followed by returning to act 803. In act 824, method 800 determines an overall count of how many bounding boxes are in the set of bounding boxes, and uses this overall count as an indicator of occupancy of seats in vehicle 299.

Various adaptations and modifications may be made without departing from the scope of the described embodiments. Numerous modifications and adaptations of the embodiments described herein are encompassed by the attached claims.

1. A method of automatically determining occupancy, the method comprising:
receiving from a camera, an image of a scene comprising a plurality of seats;
for each bounding box in a set of bounding boxes previously identified in memory:
searching for any bounding box in the image that satisfies a specific overlap condition relative to said each bounding box in the set of bounding boxes;
overwriting coordinates of said each bounding box with coordinates of said any bounding box, when the specific overlap condition is satisfied;
incrementing a count corresponding to said each bounding box when the specific overlap condition is not satisfied on completion of said searching; and
removing said each bounding box from the set of bounding boxes when the count corresponding to said each bounding box exceeds a threshold;
wherein the receiving, the searching, the overwriting, the incrementing, and the removing are performed by one or more processors coupled to the camera and to the memory.

2. The method of claim 1 further comprising:
determining an overall count of bounding boxes in the set of bounding boxes and using said overall count as an indicator of occupancy of the plurality of seats.

3. The method of claim 1 wherein:
the threshold is selected from among multiple thresholds based on a signal from a sensor, the signal being indicative of whether a vehicle in which the seats are mounted is stationary or moving.

4. The method of claim 1 wherein:
the searching is performed through a group of bounding boxes of faces of occupants of the plurality of seats in the image.

5. The method of claim 4 further comprising:
removing said any bounding box from the group of bounding boxes when the specific overlap condition is satisfied; and
adding to the set of bounding boxes, a new bounding box in the group of bounding boxes, when no bounding box in the set of bounding boxes satisfies the specific overlap condition relative to said new bounding box.

6. The method of claim 4 wherein the image is hereinafter a current image, and the group of bounding boxes is hereinafter a first group of bounding boxes, the method further comprising:
training, by use of an earlier image captured when the plurality of seats were unoccupied, to identify coordinates of a second group of bounding boxes of the plurality of seats, at least by application of a classifier to a plurality of edges detected in said earlier image.

7. The method of claim 6 wherein said count is hereinafter an existing count, the method further comprising:
checking whether a new bounding box, identified in the current image based on the coordinates of the second group of bounding boxes, is unoccupied based at least on performing background subtraction on the new bounding box in the current image; and
incrementing a new count corresponding to the new bounding box when the new bounding box is found by said checking to be unoccupied in the current image and was occupied in a prior image.

8. The method of claim 7 further comprising:
removing the new bounding box from the set of bounding boxes when the new count exceeds the threshold.

9. One or more non-transitory computer readable storage media comprising:
instructions to receive from a camera, an image of a scene comprising a plurality of seats;
instructions configured to be repeatedly executed for each bounding box in a set of bounding boxes previously identified in memory, to:
search for any bounding box in the image that satisfies a specific overlap condition relative to said each bounding box in the set of bounding boxes;
overwrite a location of said each bounding box with another location of said any bounding box, when the specific overlap condition is satisfied;
increment a count corresponding to said each bounding box when the specific overlap condition is not satisfied on completion of said searching; and
remove said each bounding box from the set of bounding boxes when the count corresponding to said each bounding box exceeds a threshold;
wherein the instructions to receive, and the instructions configured to be repeatedly executed, are to one or more processors coupled to the camera and to the memory.

10. The one or more non-transitory computer readable storage media of claim 9 further comprising:
instructions to determine an overall count of bounding boxes in the set of bounding boxes and using said overall count as an indicator of occupancy of the plurality of seats.

11. The one or more non-transitory computer readable storage media of claim 9 wherein:
the threshold is selected from among multiple thresholds based on a signal from a sensor, the signal being indicative of whether a vehicle in which the seats are mounted is stationary or moving.

12. The one or more non-transitory computer readable storage media of claim 9 wherein:
the search in the image is performed through a group of bounding boxes of faces of occupants of the plurality of seats in the image.

13. The one or more non-transitory computer readable storage media of claim 12 further comprising:
instructions to remove said any bounding box from the group of bounding boxes when the specific overlap condition is satisfied; and
instructions to add to the set of bounding boxes, a new bounding box in the group of bounding boxes, when no bounding box in the set of bounding boxes satisfies the specific overlap condition relative to said new bounding box.

14. The one or more non-transitory computer readable storage media of claim 12 wherein said image is hereinafter a current image, and said group of bounding boxes is hereinafter a first group of bounding boxes, wherein the one or more non-transitory computer readable storage media further comprise:
instructions to train, by use of an earlier image captured when the plurality of seats were unoccupied, to identify coordinates of a second group of bounding boxes of the plurality of seats, at least by application of a classifier to a plurality of edges detected in said earlier image.

15. The one or more non-transitory computer readable storage media of claim 14 wherein said count is hereinafter an existing count, wherein the one or more non-transitory computer readable storage media further comprise:
instructions to check whether a new bounding box, identified in the current image based on the coordinates of the second group of bounding boxes, is unoccupied based at least on performing background subtraction on the new bounding box in the current image; and
instructions to increment a new count corresponding to the new bounding box when the new bounding box is found by said checking to be unoccupied in the current image and was occupied in a prior image.

16. One or more devices comprising:
a camera;
one or more processors, operatively coupled to the camera;
memory, operatively coupled to the one or more processors; and
software held in the memory that when executed by the one or more processors, causes the one or more processors to:
receive from a camera, an image of a scene comprising a plurality of seats;
repeatedly perform, for each bounding box in a set of bounding boxes previously identified in memory:
search through the image, for any bounding box that satisfies a specific overlap condition relative to said each bounding box in the set of bounding boxes;
overwrite a location of said each bounding box with another location of said any bounding box, when the specific overlap condition is satisfied;
increment a count corresponding to said each bounding box when the specific overlap condition is not satisfied on completion of said searching; and
remove said each bounding box from the set of bounding boxes when the count corresponding to said each bounding box exceeds a threshold.

17. The one or more devices of claim 16 wherein the software further causes the one or more processors to:
determine an overall count of bounding boxes in the set of bounding boxes and using said overall count as an indicator of occupancy of the plurality of seats.

18. The one or more devices of claim 16 wherein:
the threshold is selected from among multiple thresholds based on a signal from a sensor, the signal being indicative of whether a vehicle in which the seats are mounted is stationary or moving.

19. The one or more devices of claim 16 wherein:
the search in the image is performed through a group of bounding boxes of faces of occupants of the plurality of seats in the image.

20. The one or more devices of claim 19 wherein the software further causes the one or more processors to:
remove said any bounding box from the group of bounding boxes when the specific overlap condition is satisfied; and
add to the set of bounding boxes, a new bounding box in the group of bounding boxes, when no bounding box in the set of bounding boxes satisfies the specific overlap condition relative to said new bounding box.
